(19) United States
(12) Patent Application Publication
(10) Pub. No.: US 2023/0153759 A1
(43) Pub. Date: May 18, 2023

(54) PROJECT MANAGEMENT ORGANIZATION DIAGNOSIS DATABASE SYSTEM

(71) Applicant: MANAGEMENT SOLUTIONS CO., LTD., Tokyo (JP)

(72) Inventors: Shinya TAKAHASHI, Tokyo (JP); Toshinari GOTO, Tokyo (JP); Ryo HASEGAWA, Tokyo (JP); Yi ZHANG, Tokyo (JP); Akira KANEKO, Tokyo (JP)

(73) Assignee: MANAGEMENT SOLUTIONS CO., LTD., Tokyo (JP)

(21) Appl. No.: 18/094,232

(22) Filed: Jan. 6, 2023

Related U.S. Application Data
(63) Continuation of application No. PCT/JP2021/026109, filed on Jul. 12, 2021.

(30) Foreign Application Priority Data
Jul. 16, 2020 (JP) 2020-121839

(51) Int. Cl. G06Q 10/10

(52) U.S. Cl. CPC G06Q 10/103

(57) ABSTRACT

A project management organization diagnosis DB system that diagnoses a proper operability which is information indicating whether a project management organization, which is an organization to manage a project, is properly installed and operated during the progress of the project, and provides a database storing a result of the diagnosis. The system includes an organization diagnosis template storage configured to storage a plurality of organization diagnosis templates each provided with a plurality of diagnosis items composed of diagnosis sentences in predetermined sentences for checking the proper operability of a project management organization, an organization diagnosis template selector configured to allow a user to select an organization diagnosis template for checking the proper operability of the project management organization being operated, and an organization diagnosis sheet register configured to register the selected organization diagnosis template as an organization diagnosis sheet in association with information to be associated.

### CROSS-REFERENCE TO RELATED APPLICATION

This application is a continuation application of International Application PCT/JP2021/026109 filed on Jul. 12, 2021 and designated the U.S., which claims the benefits of priorities of Japanese Patent Application No. 2020-121839 filed on Jul. 16, 2020, the entire contents of which are incorporated herein by reference.

### FIELD

The present invention relates to a system capable of providing a mechanism for achieving a single or a plurality of relatively large-scale projects in a relatively labor-saving manner, a mechanism for inputting and managing information for efficiently utilizing resources, and a system capable of enhancing the project achievement ability of members involved in the projects. In particular, its main feature is that the system is evaluated and diagnosed according to the progress of the project.

### BACKGROUND

The above-described system has conventionally existed as a system for judging whether a so-called project is progressing well or not. An example thereof is Japanese Laid-Open Patent Publication No. 03-198102 (hereinafter referred to as Patent Document 1).

### SUMMARY

According to an aspect of the present disclosure, there is provided a project management organization diagnosis DB system that diagnoses a proper operability which is information indicating whether a project management organization, which is an organization to manage a project, is properly installed and operated during the progress of the project, and provides a database storing a result of the diagnosis. The project management organization diagnosis DB system includes an organization diagnosis template storage configured to storage a plurality of organization diagnosis templates each provided with a plurality of diagnosis items composed of diagnosis sentences in predetermined sentences for checking the proper operability of a project management organization, an organization diagnosis template selector configured to allow a user to select an organization diagnosis template for checking the proper operability of the project management organization being operated, and an organization diagnosis sheet register configured to register the selected organization diagnosis template as an organization diagnosis sheet in association with information to be associated.

The project management organization diagnosis DB system may further include an organization diagnosis sheet comparer configured to calculate an average value for each industry, each type of industry, or each type of project based on accumulated diagnosis result information of a plurality of organization diagnoses, and set target values classified into a high level target value, a standard target value, and a low level target value.

The project diagnosis DB system may further include a functional unit configured to output an effective improvement measure for improving an evaluation value of the proper operability of the project management organization.

Each of the plurality of diagnosis items may belong to any one of organization management, process management, performance management, knowledge management, and project manager fostering management.

The organization diagnosis template may include at least a diagnosis sentence that prompts the user to answer whether a document exists that clarifies roles and responsibilities of an organization supporting a project management.

The organization diagnosis template may include at least a diagnosis sentence that prompts the user to answer whether information is shared with parties concerned, whether a consensus is formed with the parties concerned, or whether an intention is unified with the parties concerned.

The organization diagnosis template may include at least a diagnosis sentence that prompts the user to answer whether a criterion for a problem to be immediately shared with a higher-level organization is clarified, whether quantitative management is performed, or whether a department and a plan corresponding to the problem are clarified.

As described above, it is possible to provide a project management organization diagnosis DB system capable of appropriately inputting information for evaluating a status of a project management organization even by a person who is not accustomed to the project. In addition, the status evaluation of the appropriate project management organization is made based on the input information.

### BRIEF DESCRIPTION OF THE DRAWINGS

FIGS. 1A and 1B are diagrams illustrating a functional configuration of a project management organization diagnosis DB system according to a first embodiment;

FIGS. 2A to 2C are diagrams illustrating a hardware configuration of the project management organization diagnosis DB system according to the first embodiment;

FIG. 3 is a diagram illustrating a flow of processing when the project management organization diagnosis DB system according to the first embodiment is used;

FIGS. 4A and 4B are diagrams illustrating a functional configuration of the project management organization diagnosis DB system according to a second embodiment;

FIGS. 5A to 5C are diagrams illustrating a hardware configuration of the project management organization diagnosis DB system according to the second embodiment;

FIG. 6 is a diagram illustrating a flow of processing when the project management organization diagnosis DB system according to the second embodiment is used;

FIGS. 7A and 7B are diagrams illustrating a functional configuration of the project management organization diagnosis DB system according to a third embodiment;

FIGS. 8A to 8C are diagrams illustrating a hardware configuration of the project management organization diagnosis DB system according to the third embodiment;

FIG. 9 is a diagram illustrating a flow of processing when the project management organization diagnosis DB system according to the third embodiment is used;

FIGS. 10A and 10B are diagrams illustrating a functional configuration of a project management organization diagnosis database system according to a fourth embodiment;

FIGS. 11A to 11C are diagrams illustrating a hardware configuration of the project management organization diagnosis database system according to the fourth embodiment;

FIG. 12 is a diagram illustrating a flow of processing when the project management organization diagnosis DB system according to the fourth embodiment is used.

FIGS. 13A and 13B are diagrams illustrating a functional configuration of the project management organization diagnosis DB system according to a fifth embodiment;

FIGS. 14A to 14C are diagrams illustrating a hardware configuration of the project management organization diagnosis database system according to the fifth embodiment;

FIG. 15 is a diagram illustrating a flow of processing when the project management organization diagnosis DB system according to the fifth embodiment is used;

FIGS. 16A and 16B are diagrams illustrating a functional configuration of the project management organization diagnosis DB system according to a sixth embodiment;

FIGS. 17A to 17C are diagrams illustrating a hardware configuration of the project management organization diagnosis DB system according to the sixth embodiment;

FIG. 18 is a diagram illustrating a flow of processing when the project management organization diagnosis DB system according to the sixth embodiment is used;

FIGS. 19A and 19B are diagrams illustrating a functional configuration of the project management organization diagnosis DB system according to a seventh embodiment;

FIGS. 20A to 20C are diagrams illustrating a hardware configuration of the project management organization diagnosis DB system according to the seventh embodiment;

FIG. 21 is a diagram illustrating a flow of processing when the project management organization diagnosis DB system according to the seventh embodiment is used.

FIGS. 22A and 22B are diagrams illustrating a functional configuration of the project management organization diagnosis DB system according to an eighth embodiment;

FIGS. 23A to 23C are diagrams illustrating a hardware configuration of the project management organization diagnosis DB system according to the eighth embodiment;

FIG. 24 is a diagram illustrating a flow of processing when the project management organization diagnosis DB system according to the eighth embodiment is used;

FIGS. 25A and 25B are diagrams illustrating a functional configuration of the project management organization diagnosis DB system according to a ninth embodiment;

FIGS. 26A to 26C are diagrams illustrating a hardware configuration of the project management organization diagnosis DB system according to the ninth embodiment;

FIG. 27 is a diagram illustrating a flow of processing when the project diagnosis DB system according to the ninth embodiment is used;

FIGS. 28A and 28B are diagrams illustrating a functional configuration of the project management organization diagnosis DB system according to a tenth embodiment;

FIGS. 29A to 29C are diagrams illustrating a hardware configuration of the project management organization diagnosis DB system according to the tenth embodiment;

FIG. 30 is a diagram illustrating a flow of processing when the project management organization diagnosis DB system according to the tenth embodiment is used;

FIGS. 31A and 31B are diagrams illustrating a functional configuration of the project management organization diagnosis DB system according to an eleventh embodiment;

FIGS. 32A to 32C are diagrams illustrating a hardware configuration of a project management organization diagnosis DB system according to the eleventh embodiment;

FIG. 33 is a diagram illustrating a flow of processing when the project management organization diagnosis DB system according to the eleventh embodiment is used;

FIG. 34 is a diagram illustrating a classification that classifies a plurality of diagnosis items; and

FIG. 35 is a diagram illustrating an example of a diagnosis sentence of an organization diagnosis template.

### DESCRIPTION OF EMBODIMENTS

Patent Document 1 discloses a technical idea or problem of diagnosing a project success probability in a project progress stage.

However, according to Patent Document 1, a user who wishes to perform a project diagnosis freely considers the contents of input each time and wishes to perform the diagnosis, and it is difficult to perform appropriate input unless the user is originally accustomed to a project. As a result, the optimal organization diagnosis could not be implemented.

This disclosure provides a project management organization diagnosis database (DB) system that allows even a person unfamiliar with the project to enter information appropriately.

Embodiments of the present disclosure will be described below with reference to the accompanying drawings. Each claim is not limited to the following embodiments, and various changes and modifications may be made to the embodiments without departing from the scope of the invention disclosed in the claims.

<Hardware Constituting the Present System>

The system is basically an embodiment using a computer, but is realized by software, by hardware, or by cooperation between software and hardware. The hardware for realizing all or part of the constituent elements of the disclosure comprises a CPU, a memory, a bus, an input/output device, various peripheral devices, a user interface and the like which are basic components of a computer. The various peripheral devices include storage devices, interfaces such as the Internet, devices such as the Internet, displays, keyboards, mice, speakers, cameras, videos, televisions, various sensors for monitoring production conditions in laboratories or factories (e.g. flow rate sensors, temperature sensors, weight sensors, liquid amount sensors, infrared sensors, shipment number counters, packaging number counters, foreign matter inspection devices, defect counters, radiation inspection devices, surface condition inspection devices, circuit inspection devices, human sensors, workers' work situation monitoring devices (images, ID, PC work volume, etc.)), CD devices, DVD devices, Blu-ray devices, USB memories, USB memory interfaces, removable hard disks, general hard disks, projector devices, SSDs, telephones, faxes, copiers, printing devices, movie editing devices, and various sensor devices. Further, the present system does not necessarily have to be constituted by one housing, but may be constituted by connecting a plurality of housings by communication. Further, the communication may be a local area network (LAN), a WANWifi, Bluetooth (registered trademark), infrared communication, or ultrasonic communication, and a part of the communication may be installed across national borders. Further, each of the plurality of housings may be operated by a different entity or may be operated by a single entity. The operating entity of the system of the present disclosure may be a single entity or a plurality of entities. In addition to the present system, the embodiment can also be constituted as a system including a terminal used by a third party and a terminal used by another third party. Further, these terminals may be installed across national borders. Further, in addition to the present system and the terminal, a device used for registering related information of a third person and related persons, a device used for a database for recording the contents of the registration, and the like may be prepared. These information may be provided in the present system, or the present system may be configured to be provided outside the present system so that these information can be used.

<Fulfillment of Applicability of Natural Law of Present System>

The system functions in cooperation between a computer, a communication facility, and software. In addition to simply using ICTs (Information and Communication Technology) to process the processes conventionally performed by project participants in interviews, the project management organization uses ICTs to determine the effects of many complex information exchanges, procedures, certifications, and payments related to the project management organization, and ICTs to support the accumulation, retention, and exchange of effective information that meets all necessary requirements that cannot be created without expertise. In addition, various identification information, risk information, problem information, and task information are held or processed in each unit. From this point of view as well, if resources such as computers are determined based on the matters described in the claims and the description and the common general knowledge related to those matters, the system of the present application is considered to utilize a law of nature.

<Significance of Use of Natural Laws Required by the Patent Law>

The utilization of the natural laws required by the Patent Law is required to ensure that an invention is industrially useful from the viewpoint that the invention must have industrial applicability and contribute to the development of industry based on the nature. In other words, it is required that the invention is industrially useful, that is, the effect of the invention declared at the time of filing can be reproduced by carrying out the invention with a certain degree of certainty. From this point of view, the applicability of the laws of nature is interpreted as meaning that the function of each of the matters used to define the invention (the constituent elements of the invention), which is the constitution of the invention for exerting the effect of the invention, can be exerted by utilizing the laws of nature. Furthermore, the effect of an invention should only be the possibility of providing a prescribed usefulness to the user who uses the invention, and should not be seen in terms of how the user feels or thinks about the usefulness. Therefore, even if the effect obtained by the user by this system is a psychological effect, the effect itself is an event outside the scope of the utilization of the required laws of nature.

### First Embodiment

Provided is a project management organization diagnosis database (DB) system for diagnosing proper operability which is information indicating whether a project management organization that manages a project is properly installed and operated during the progress of the project, and providing a database storing the results thereof, a plurality of organization diagnosis templates each provided with a plurality of diagnosis items composed of diagnosis sentences in predetermined sentences for checking the proper operability of a project management organization are stored, a user is made to select an organization diagnosis template for checking the proper operability of the project management organization being operated, organization identification information which is identification information of the organization to be diagnosed is acquired in order to associate with an organization diagnosis sheet described later, an organization diagnosis sheet including the selected organization diagnosis template is registered in association with information to be associated, an organization diagnosis input which is an input for judging whether the project management organization is properly operated for each diagnosis item of the organization diagnosis sheet, an evaluation rule for evaluating the received organization diagnosis input is stored, and the proper operability of the project management organization is evaluated based on the stored evaluation rule and the inputted organization diagnosis input.

The functional configuration, the hardware configuration and the flow of processing of the project management organization diagnosis DB system according to the present embodiment will be described in order.

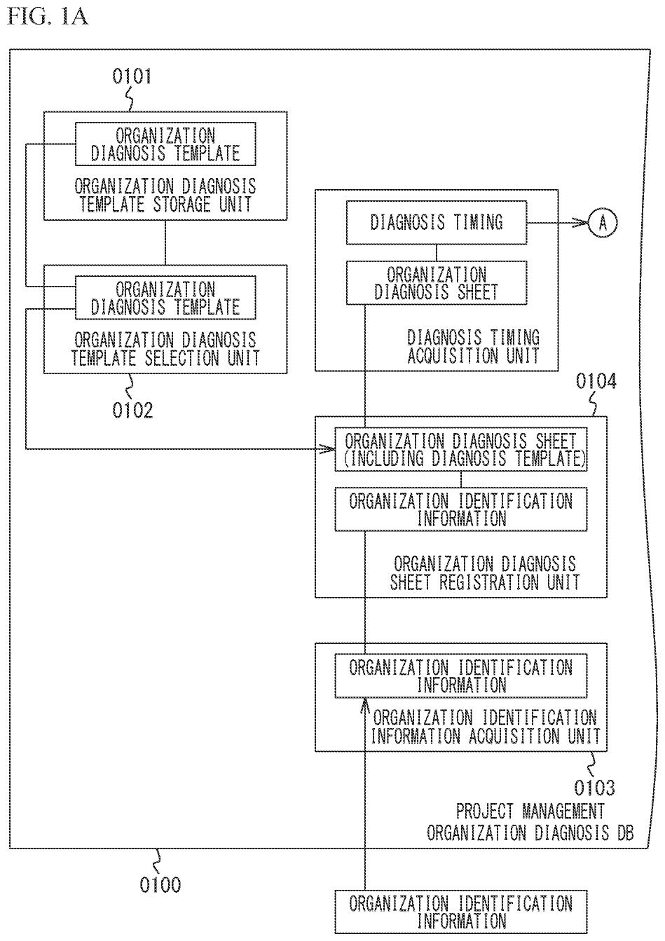

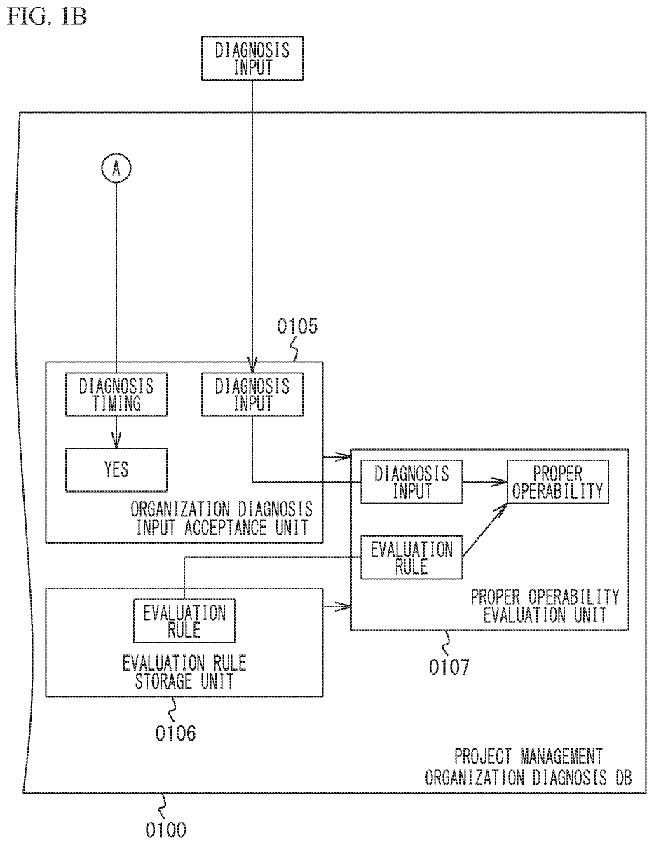

FIGS. 1A and 1B are diagrams illustrating the functional configuration of the project management organization diagnosis DB system according to the first embodiment. A project management organization diagnosis DB system (0100) of the present embodiment includes an organization diagnosis template storage unit (0101), an organization diagnosis template selection unit (0102), an organization identification information acquisition unit (0103), an organization diagnosis sheet registration unit (0104), an organization diagnosis input acceptance unit (0105), an evaluation rule storage unit (0106), and a proper operability evaluation unit (0107). Further, the project management organization diagnosis DB system includes a timing registration unit and a diagnosis timing determination unit. The same applies to the following embodiments.

The present system diagnoses proper operability which is information indicating whether a project management organization that manages a project is properly installed and operated during the progress of the project and provides a database storing the results thereof, which is the same in all the following embodiments.

The “organization diagnosis template storage unit” has a function of storing a plurality of organization diagnosis templates each provided with a plurality of diagnosis items composed of diagnosis sentences in predetermined sentences for checking the proper operability of a project management organization. It is desirable that the “organization diagnosis template” has a hierarchical structure in which the plurality of diagnosis items constitute a project management type which is a middle management layer, a plurality of project management types constitute a knowledge area which is a higher layer, and a plurality of knowledge areas constitute the whole. Further, it is preferable that the project management type of the organization diagnosis template stored in the organization diagnosis template storage unit includes at least one of a “organization management type” for quantitatively diagnosing the project management organization from the viewpoint of organization and role, a “process management type” for quantitatively diagnosing the project management organization from the viewpoint of process, an “execution management type” for quantitatively diagnosing the project management organization from the viewpoint of performance and result, a “resource management type” for quantitatively diagnosing the project management organization from the viewpoint of training of management personnel, and a “knowledge management type” for quantitatively diagnosing the project management organization from the viewpoint of utilizing know-how and lessons.

The “organization diagnosis template” is used to diagnose the project management organization, and is used by the parties responsible for the project to fill in the information required in the organization diagnosis template. Typically, the organization diagnosis template is configured to be selected from pull-down menus, check boxes, drop-down forms, etc., or to be filled in or selected by determining the level. As a result of examining what conditions are necessary for the success of the project management organization, the organization diagnosis template proved academically appropriate to have the following structure.

First, the situation of the project is examined in the following major items. The major items are defined as organization, process, execution, resource, and knowledge.

“Organization” is a template area for checking which departments, functions, and roles within the organization have what responsibilities and whether each department, function, and role cooperates with each other and is effective for the three management areas of portfolio management, program management, and project management.

“Process” is a template area for checking whether processes are standardized and continuously improved in the organization for the three management areas of portfolio management, program management and project management.

“Execution” is a template area for checking whether the management is properly executed, the situation is understood quantitatively, and problems are detected and solved for the three management areas of portfolio management, program management, and project management.

“Resources” is a template area for checking whether there are career paths, evaluation criteria and training programs for project management personnel such as project managers and project leaders, and whether they are developed appropriately.

“Knowledge” is a template area for checking whether there is a mechanism to systematically collect, organize, and develop knowledge and lessons learned from past projects and utilize them for future projects, and whether it is properly operated.

The final diagnosis items of the organization diagnosis template has a conceptually hierarchical structure such as major items (for example, “process management”), intermediate items (for example, “risk management”), and minor items (for example, “a conference for discussing risk measures exists”).

The “organization diagnosis template” may be selectable in units of intermediate items, in units of major items, or even a collection of major items as a whole. Preferably, however, the organization diagnosis template is configured to be selected as the collection of major items because the diagnosis items are interrelated and also intermediate items and major items are interrelated.

The stored “organization diagnosis template” is comprehensively prepared so as to be applicable to various organizations. The system then automatically guesses and recommends a suitable template based on the stored organization and the stored project information. In addition, the user can freely select a template from the screen. Therefore, the user can select the template which is most suitable for the organization which he/she intends to transition to the diagnosis.

The embodiments are characterized in that a template can be selected from a collection of templates. In addition, the selected template adopts a style of multi-faceted diagnosis of the essential management items in the project management organization indicated by the intermediate items located in the upper level between the diagnosis items in advance, so that the absence of diagnosis does not occur. Although some of the essential management items may differ depending on the type of organization, the essential management items corresponding to almost all types of organizations constitute the organizational diagnosis template and can be selected.

The “organization diagnosis template selection unit” has a function of allowing the user to select an organization diagnosis template for checking the proper operability of the project management organization being operated. The selection of the organization diagnosis template is displayed on the display in the form of a table of contents, and the interface is configured so that the contents of the template can be gradually recognized in a hierarchical structure. The lowest layer of the hierarchical structure is the diagnosis item itself of the organization diagnosis template. The selection is configured to be selected by check boxes, pull-down menus, drop-down forms, etc. It is preferable that the user can browse and refer to the configuration of the past organization diagnosis sheet at the time of selection. This is because the qualification of the diagnosis can be judged by knowing the diagnosis contents of the past successful project management organization.

The “organization diagnosis sheet registration unit” has a function of registering the selected organization diagnosis template as an organization diagnosis sheet in association with information to be associated. The information to be associated includes a diagnosis timing (name of the diagnosis timing such as an initial period, a half period, and a final period), a scheduled diagnosis date, an organization to which a diagnostician belongs, the diagnostician, and an organization to be diagnosed. By the registration, the contents of the organization diagnosis sheet are determined.

The “organization diagnosis input acceptance unit” has a function of accepting an organization diagnosis input which is an input for judging whether the project management organization is properly operated for each diagnosis item of the organization diagnosis sheet. In addition, the organization diagnosis input acceptance unit may have a predetermined format input acceptance unit configured to perform at least one of selection of an option for the diagnosis item of the organization diagnosis template and input of a numerical value level determined within a predetermined range.

The “evaluation rule storage unit” has a function of storing an evaluation rule for evaluating the accepted organization diagnosis input. The evaluation rule may, for example, make the areas of “1-1. Establishment of PMO Organization”, “2-1. Establishment of PMO Process” and “3-3. Project Management” of the evaluation items more important than other areas.

The “proper operability evaluation unit” has a function of evaluating the proper operability of the project management organization based on the stored evaluation rule and the inputted organization diagnosis input.

It is desirable that the proper operability evaluation unit has a major item evaluation unit for evaluating the project management organization in units of major items of the organization diagnosis template at each diagnosis timing.

Further, in the embodiments, in addition to the above-described features, it is desirable that the proper operability evaluation unit has a common evaluation unit for evaluating at least a part of evaluations on a common evaluation axis even when templates included in different organization diagnosis sheets are selected and diagnosis results are input.

Although the basic configuration of the present system has been described above, the present system may further include an “organization diagnosis sheet generating unit” which may have a function of generating the organization diagnosis sheet including the organization diagnosis sheet based on the selected organization diagnosis template. When the organization diagnosis sheet is generated, the organization diagnosis template used for diagnosis of the project is basically determined. At this point, the selection of the organization diagnosis template is completed. However, it may be possible to return to the selection of the project diagnosis template after the generation.

The system may further include a “timing acquisition unit” which may have a function of registering a diagnosis timing for diagnosing the project management organization using the registered organization diagnosis sheet, in association with organization identification information. This function is not required, but it is flexible to make decisions by inputting the timing. The diagnosis timing of the project management organization is basically at the timing corresponding to the fiscal year (initial period, half period, final period, etc.) adopted by the company.

The system may optionally include a “diagnosis timing judgment unit”. The “diagnosis timing judgment unit” has a function of judging whether the registered diagnosis timing has arrived.

<Hardware Configuration>

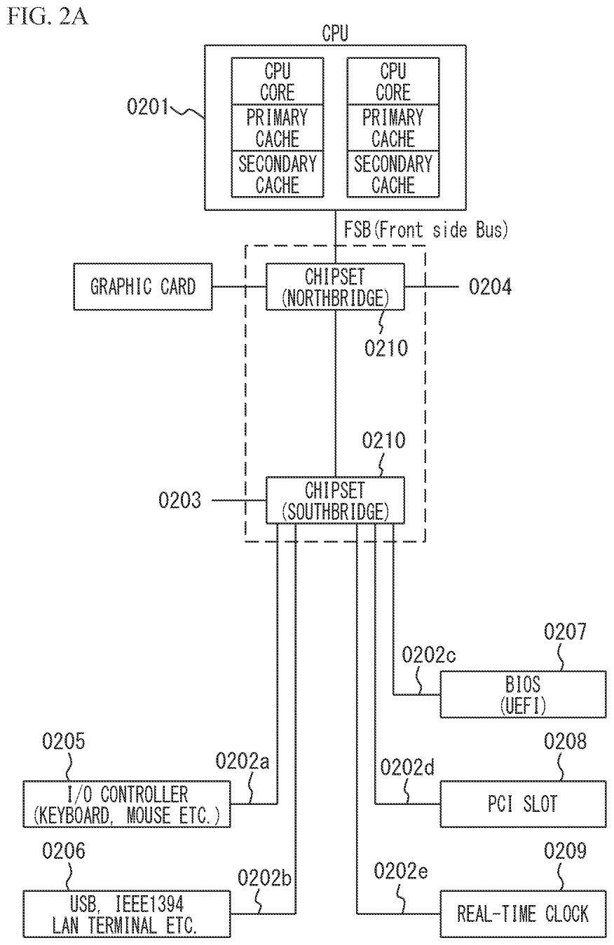

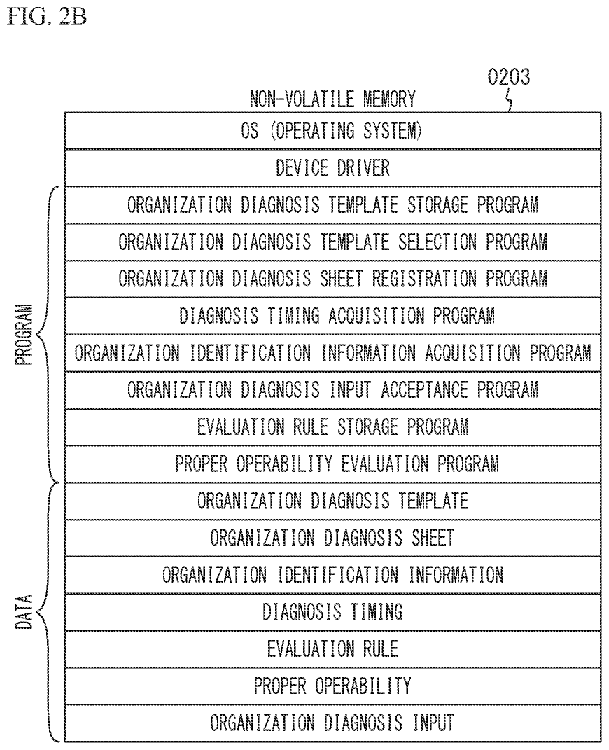

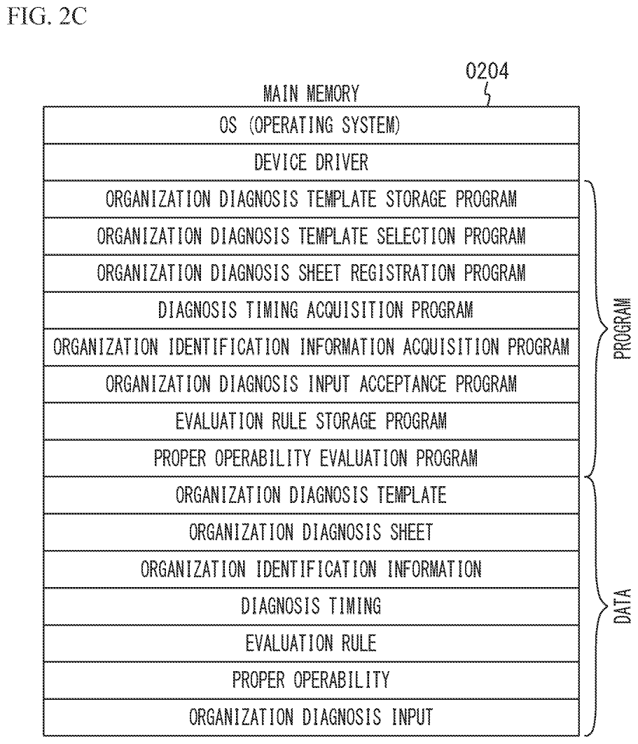

FIGS. 2A to 2C are diagrams illustrating an example of the hardware configuration in the present embodiment. The hardware configuration of the project management organization diagnosis DB system according to the present embodiment will be described with reference to drawings.

As illustrated in FIGS. 2A to 2C, a computer includes a chip set (0210), a CPU (0201), a non-volatile memory (0203), a main memory (0204), various buses (0202a to 0202e), a BIOS (0207), various interfaces (0205, 0206, 0208), a real-time clock (0209), and the like, which are configured on a motherboard. They work in conjunction with operating systems, device drivers and programs. Various programs and various data constituting the embodiment are configured to execute various processes by efficiently utilizing these hardware resources.

<Chipset>

The “chipset” is a set of large-scale integrated circuits (LSI) mounted on a motherboard of the computer and integrated with a communications function, i.e., a bridge function between an external bus of CPUs and a standard bus for connecting memories and peripheral devices. A two chip set configuration may be employed or a one chip set configuration may be employed. A north bridge is provided near the CPU and main memory, and a south bridge is provided near an interface with the external I/O which is relatively low speed.

(North Bridge)

The north bridge includes a CPU interface, a memory controller, and a graphics interface. Most of the functions of the conventional north bridge may be carried out by the CPU. The north bridge is connected to the memory slot of the main memory through a memory bus, and to a graphics card slot of a graphics card through a high-speed graphics bus (AGP, PCI Express).

(South Bridge)

The south bridge is connected to a PCI interface (PCI slot) via a PCI bus and performs I/O functions and sound functions with an ATA (SATA) interface, a USB interface, an Ethernet interface, etc. The incorporation of circuits that support PS/2 ports, floppy disk drives, serial ports, parallel ports, and ISA buses for which high-speed operation is not necessary or possible is a drag on the speedup of the chip set itself, so the circuits may be separated from the south bridge chip and placed in charge of another LSI called a Super I/O chip. Buses are used to connect the CPU (MPU) to peripheral devices and various control units. The buses are connected to the chip set. A memory bus used for connection with the main memory may adopt a channel structure instead of the memory bus in order to achieve high speed. A serial bus or a parallel bus can be adopted as the bus. In the parallel bus, while the serial bus transfers data one bit at a time, the original data itself or a plurality of bits extracted from the original data are bundled into one block and transmitted simultaneously through a plurality of communication paths. A dedicated line for the clock signal is provided in parallel with a data line to synchronize data demodulation on the receiving side. It is also used as a bus to connect a CPU (chip set) and external devices, such as GPIB, IDE/(parallel) ATA, SCSI, and PCI. Since there is a limit to the speedup, the data line may be the serial bus in the improved PCI Express of PCI or the improved serial ATA of parallel ATA.

<CPU>

The CPU reads a sequence of instructions called a program in the main memory in order, interprets and executes them, and outputs information composed of signals to the main memory. The CPU functions as a center of operation in the computer. It should be noted that the CPU is composed of a CPU core part as a center of calculation and peripheral parts thereof, and includes a register, a cache memory, an internal bus for connecting the cache memory and the CPU core, a DMA controller, a timer, an interface with a connection bus to the north bridge, and the like inside the CPU. A plurality of CPU cores may be provided in one CPU (chip). In addition to the CPU, processing may be performed by a graphic interface (GPU) or an FPU.

<Non-Volatile Memory> (HDD)

The basic structure of a hard disk drive comprises a magnetic disk, a magnetic head, and an arm on which the magnetic head is mounted. The external interface can be SATA (ATA in the past). Communication between hard disk drives is supported by using a high-functional controller, such as SCSI. For example, when a file is copied to another hard disk drive, the controller can read the sector, transfer and write it to another hard disk drive. At this time, the memory of the host CPU is not accessed. Therefore, it is not necessary to increase the load of the CPU.

<Main Memory>

The CPU directly accesses and executes various programs on main memory. The main memory is a volatile memory using DRAM. The program on the main memory is developed from the non-volatile memory onto the main memory in response to an instruction to start the program. Thereafter, the CPU executes the program in accordance with various execution instructions and execution procedures in the program.

<Operating System (OS)>

The operating system is used to manage resources on the computer for applications, manage various device drivers, and manage the computer itself which is hardware. In a small computer, firmware may be used as the operating system.

<BIOS>

The BIOS is the hardware which causes the CPU to execute the procedure for starting up the hardware of the computer and operating the operating system, and is most typically the hardware which the CPU first reads when the computer is instructed to start. The address of the operating system stored in the disk (non-volatile memory) is described therein, and the operating system is sequentially expanded in the main memory by the BIOS expanded in the CPU to be in an operating state. The BIOS also has a check function for checking the presence or absence of various devices connected to the bus. The results of the checks are stored in main memory and made available to the operating system as appropriate. The BIOS may be configured to check an external device or the like.

The above is also applicable to other embodiments.

As illustrated in FIGS. 2A to 2C, the embodiment can be basically constituted by general-purpose computer programs and various devices. The operation of a computer basically takes a form in which programs recorded in the nonvolatile memory is loaded into the main memory and processing is executed by the main memory, the CPU, and various devices. Communication with the devices is performed through an interface connected to a bus line. The interface may be a display interface, a keyboard, a communication buffer, or the like.

As illustrated in FIGS. 2A to 2C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other.

<Flow of Processing>

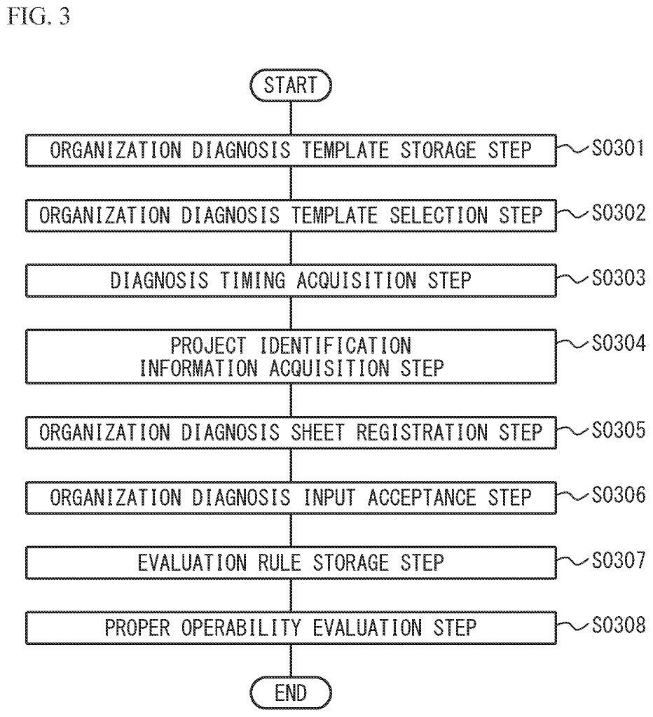

FIG. 3 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S0301), an organization diagnosis template selection step (S0302), a diagnosis timing acquisition step (S0303), an organization identification information acquisition step (S0304), an organization diagnosis sheet registration step (S0305), an organization diagnosis input acceptance step (S0306), an evaluation rule storage step (S0307), and a proper operability evaluation step (S0308). In addition, an organization diagnosis sheet generation step, a timing registration step, and a diagnosis timing judgment step may be provided, and the same applies to other embodiments. Each step will be described below.

The “organization diagnosis template storage step” is a step of storing the plurality of organization diagnosis templates composed of diagnosis sentences in predetermined sentences for checking the proper operability of the project management organization.

The “organization diagnosis template selection step” is a step of allowing the user to select the organization diagnosis template for checking the proper operability of the project management organization being operated.

The “organization identification information acquisition step” is a step of acquiring the organization identification information, which is the identification information of the organization to be diagnosed, in order to associate it with the organization diagnosis sheet described later.

The “organization diagnosis sheet registration step” is a step of registering the organization diagnosis sheet including the selected organization diagnosis template in association with information to be associated.

The “organization diagnosis input acceptance step” is a step of accepting the organization diagnosis input which is the input for judging whether the project management organization is properly operated for each diagnosis item of the organization diagnosis sheet.

The “evaluation rule storage step” is a step of storing the evaluation rule for evaluating the accepted organization diagnosis input.

The “proper operability evaluation step” is a step of evaluating the proper operability of the project management organization based on the stored evaluation rule and the input diagnosis result.

The “organization diagnosis sheet generation step” may be included in addition to the above. The “organization diagnosis sheet generation step” is a step of generating the organization diagnosis sheet including the selected organization diagnosis template based on the selected organization diagnosis template.

The “timing registration step” is a step of registering a diagnosis timing, which is a timing for diagnosing the project management organization using the registered organization diagnosis sheet, in association with the organization identification information.

The “diagnosis timing judgment step” is a step of judging whether the registered diagnosis timing has arrived.

### Second Embodiment

In addition to the above-described embodiments, this embodiment provides a project management organization diagnosis DB system having a function of acquiring diagnostician identification information for identifying a diagnostician who executes an organization diagnosis input into a diagnosis sheet in order to associate it with the organization diagnosis sheet.

<Functional Configuration>

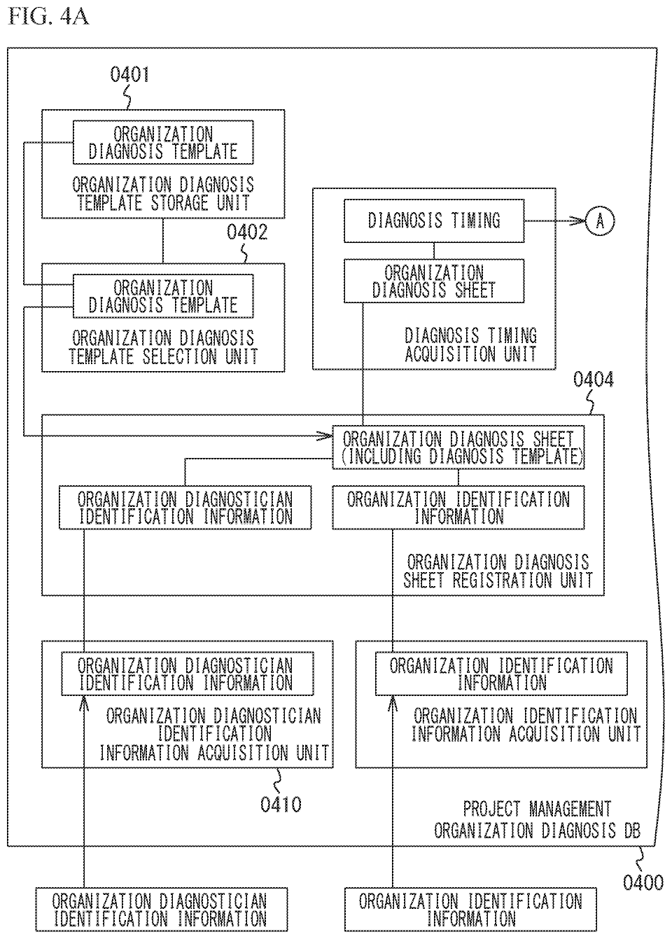

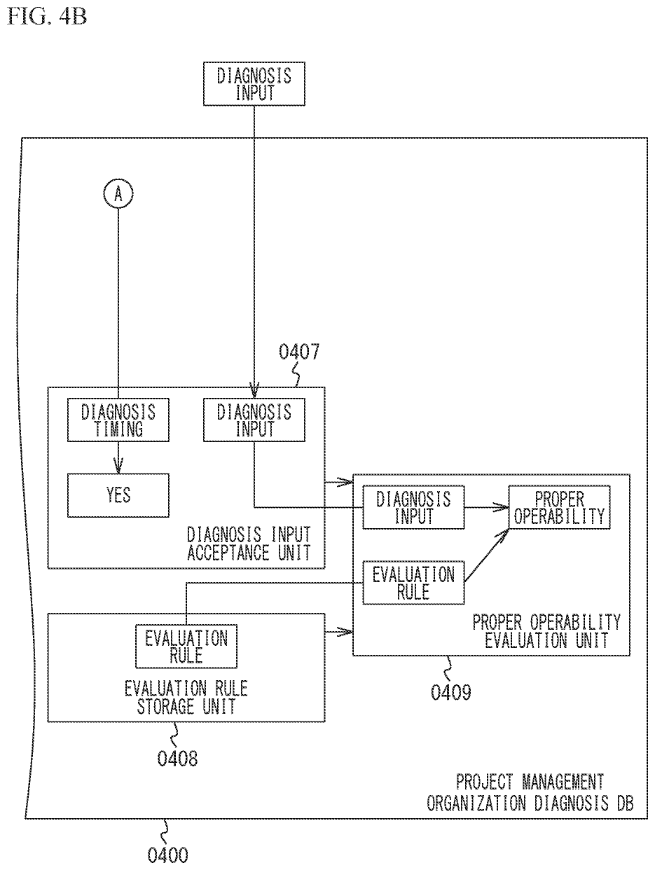

FIGS. 4A and 4B are diagrams illustrating the functional configuration according to the present embodiment. The project management organization diagnosis DB system (0400) of the present embodiment includes an organization diagnosis template storage unit (0401), an organization diagnosis template selection unit (0402), an organization identification information acquisition unit (0403), an organization diagnosis sheet registration unit (0404), an organization diagnosis input acceptance unit (0407), an evaluation rule storage unit (0408), and a proper operability evaluation unit (0409) as in the first embodiment, and further has an organization diagnostician identification information acquisition unit (0410). The description will be made except for the functions already described.

The “organization diagnostician identification information acquisition unit” has a function of acquiring organization diagnostician identification information for identifying a diagnostician who executes an organization diagnosis input into the organization diagnosis sheet in order to associate it with the organization diagnosis sheet.

<Hardware Configuration>

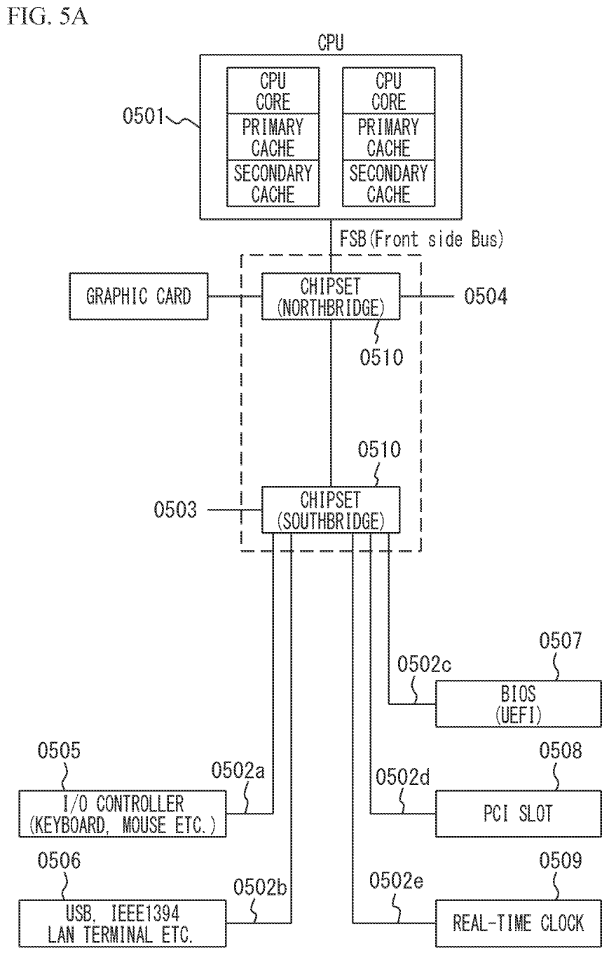

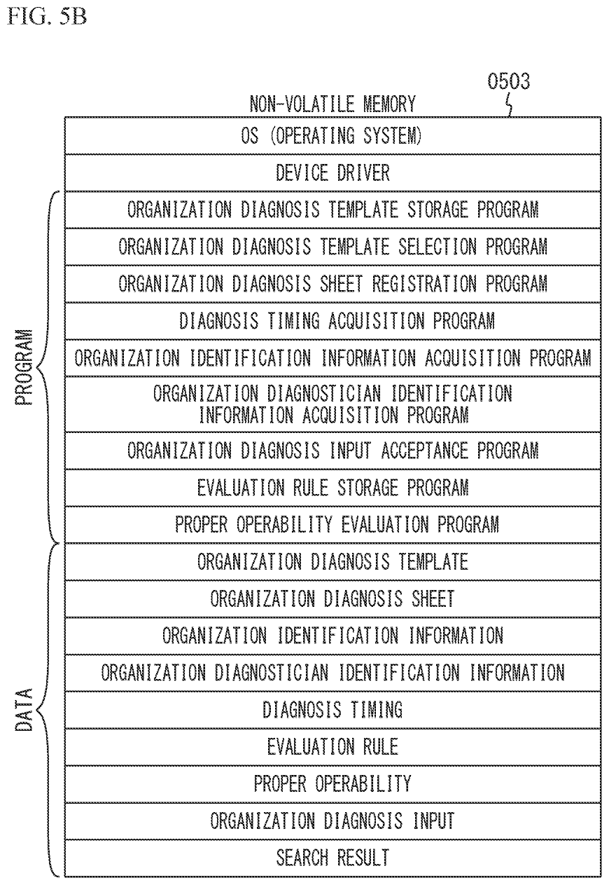

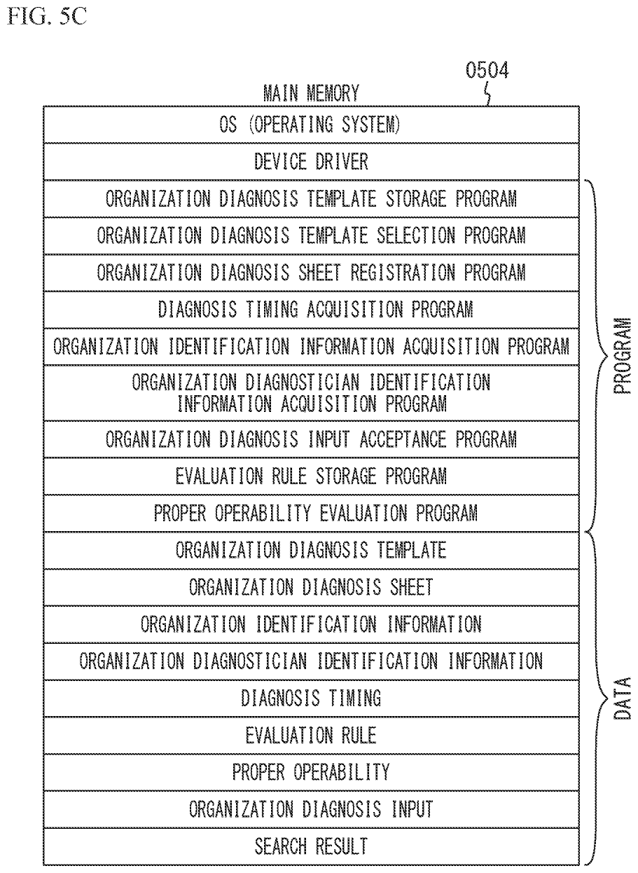

FIGS. 5A to 5C are diagrams illustrating a hardware configuration of the project management organization diagnosis DB system according to the present embodiment. As illustrated in FIGS. 5A to 5C, the computer includes a chip set (0510), a CPU (0501), a non-volatile memory (0503), a main memory (0504), various buses (0502a to 0502e), a BIOS (0507), various interfaces (0505, 0506, 0508), a real-time clock (0509), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 5A to 5C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnostician identification information acquisition program” for acquiring organization diagnostician identification information for identifying the diagnostician who executes the organization diagnosis input into the organization diagnosis sheet in order to associate it with the organization diagnosis sheet.

<Flow of Processing>

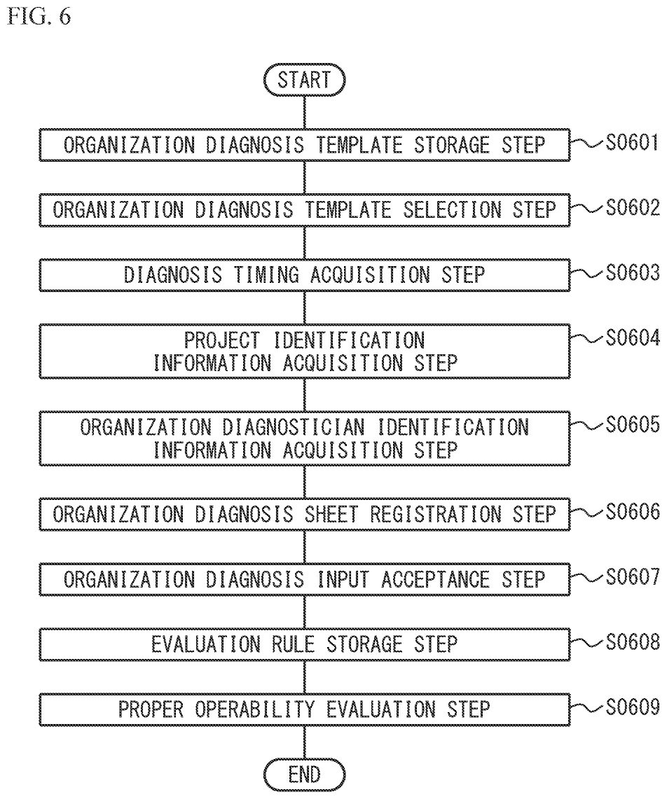

FIG. 6 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S0601), an organization diagnosis template selection step (S0602), a diagnosis timing acquisition step (S0603), an organization identification information acquisition step (S0604), an organization diagnostician identification information acquisition step (S0605), an organization diagnosis sheet registration step (S0606), an organization diagnosis input acceptance step (S0607), an evaluation rule storage step (S0608), and a proper operability evaluation step (S0609). The steps other than the organization diagnostician identification information acquisition step are the same as those in the first embodiment.

The “organization diagnostician identification information acquisition step” is a step of acquiring organization diagnostician identification information for identifying the diagnostician who executes the organization diagnosis input into the organization diagnosis sheet in order to associate it with the organization diagnosis sheet.

### Third Embodiment

In addition to the above-described embodiments, the present embodiment provides a project management organization diagnosis DB system having a function of storing a plurality of organization diagnosis sheets associated with organization identification information.

<Functional Configuration>

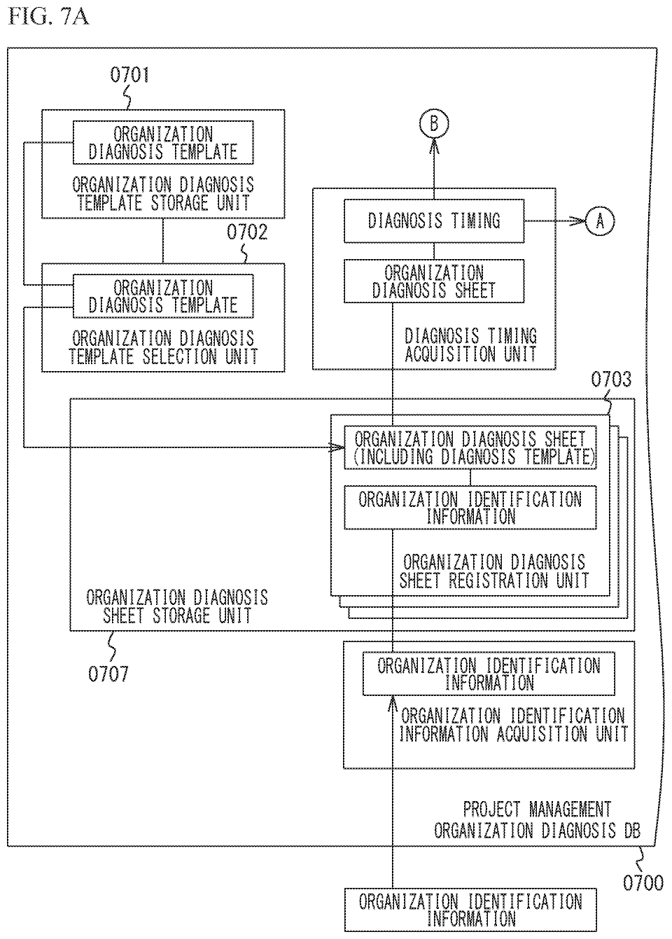

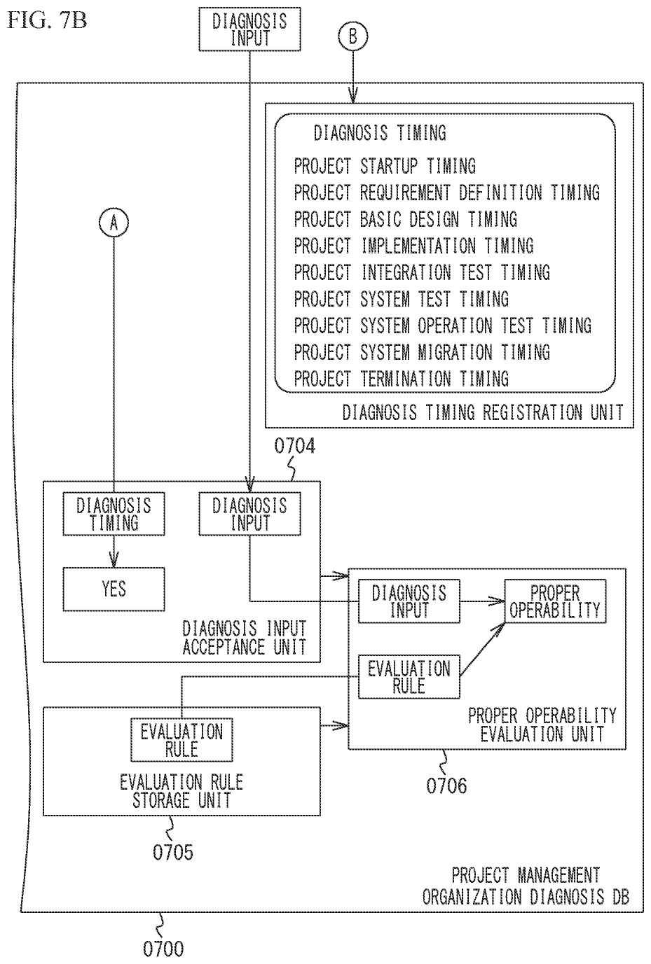

FIGS. 7A and 7B are diagrams illustrating the functional configuration according to the present embodiment. The project management organization diagnosis DB system (0700) of the present embodiment includes an organization diagnosis template storage unit (0701), an organization diagnosis template selection unit (0702), an organization diagnosis sheet registration unit (0703), an organization diagnosis input acceptance unit (0704), an evaluation rule storage unit (0705), and a proper operability evaluation unit (0706) as in the first embodiment, and further has an organization diagnosis sheet storage unit (0707) storing a plurality of organization diagnosis sheets associated with the organization identification information. The description will be made except for the functions already described.

The “organization diagnosis sheet storage unit” has a function of storing the plurality of project diagnosis sheets associated with the organization identification information.

<Hardware Configuration>

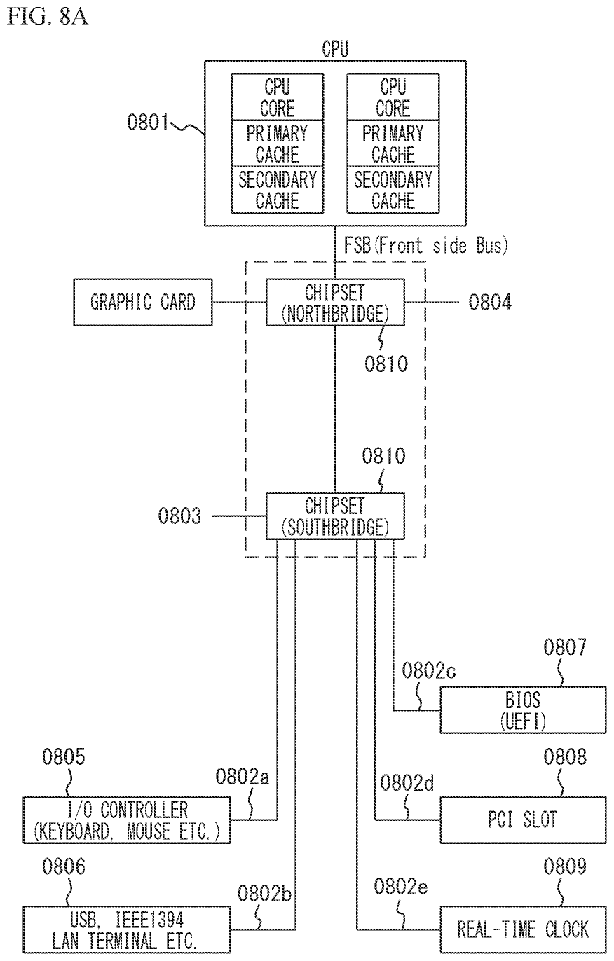

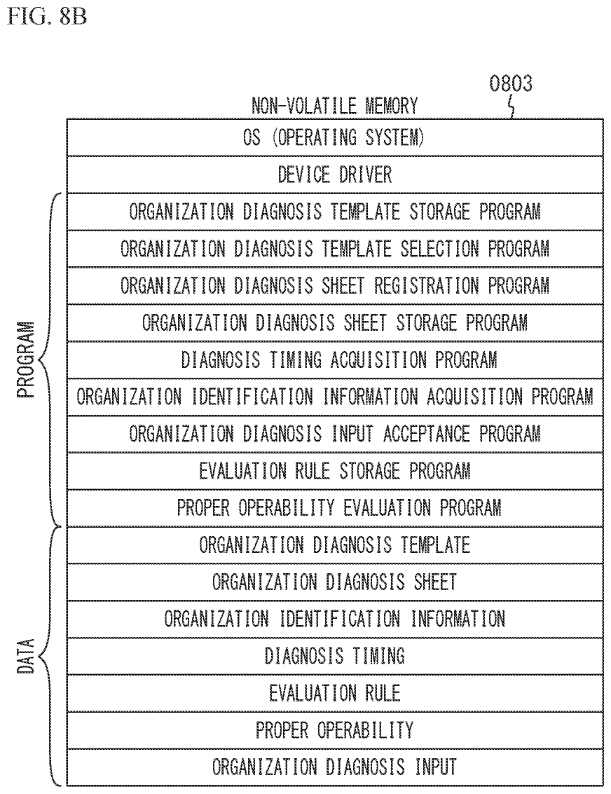

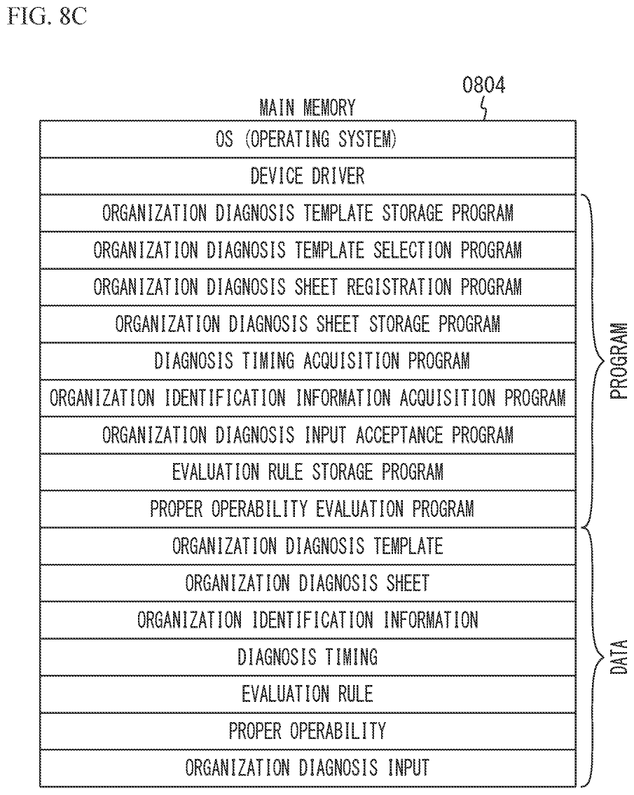

FIGS. 8A to 8C are diagrams illustrating a hardware configuration of the project management organization diagnosis DB system according to the present embodiment. As illustrated in FIGS. 8A to 8C, the computer includes a chip set (0810), a CPU (0801), a non-volatile memory (0803), a main memory (0804), various buses (0802a to 0802e), a BIOS (0807), various interfaces (0805, 0806, 0808), a real-time clock (0809), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 8A to 8C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis sheet storage program” for storing the plurality of project diagnosis sheets associated with the organization identification information.

<Flow of Processing>

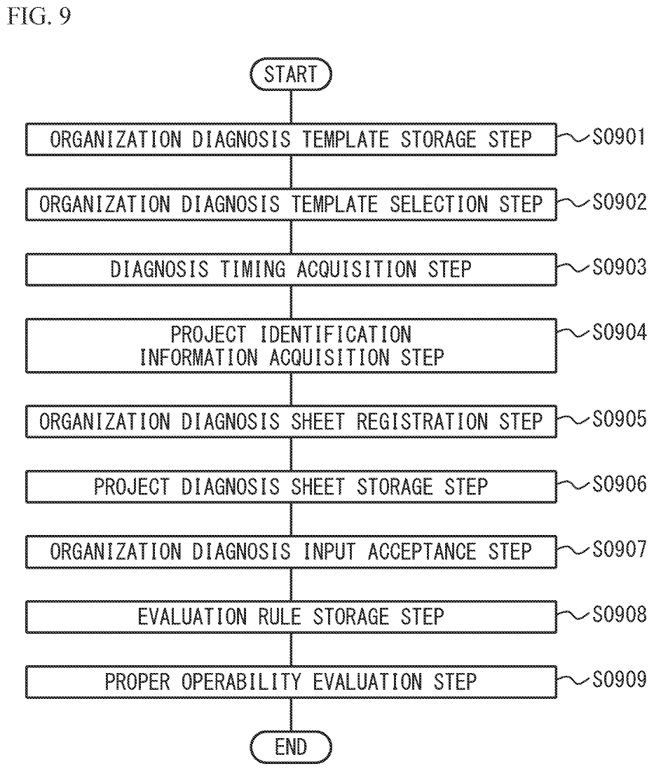

FIG. 9 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S0901), an organization diagnosis template selection step (S0902), a diagnosis timing acquisition step (S0903), an organization identification information acquisition step (S0904), an organization diagnosis sheet storage step (S0906), an organization diagnosis sheet registration step (S0905), an organization diagnosis input acceptance step (S0907), an evaluation rule storage step (S0908), and a proper operability evaluation step (S0909). The steps other than the organization diagnosis sheet storage step are the same as those in the first embodiment.

The “organization diagnosis sheet storage step” is a step of storing the plurality of organization diagnosis sheets associated with the project identification information.

### Fourth Embodiment

In addition to the above-described embodiments, this embodiment provides a project management organization diagnosis DB system having a function of registering at least one timing corresponding to a fiscal year (initial period, half period, end period, etc.) basically adopted by a company as a timing for accepting input of a diagnosis result.

<Functional Configuration>

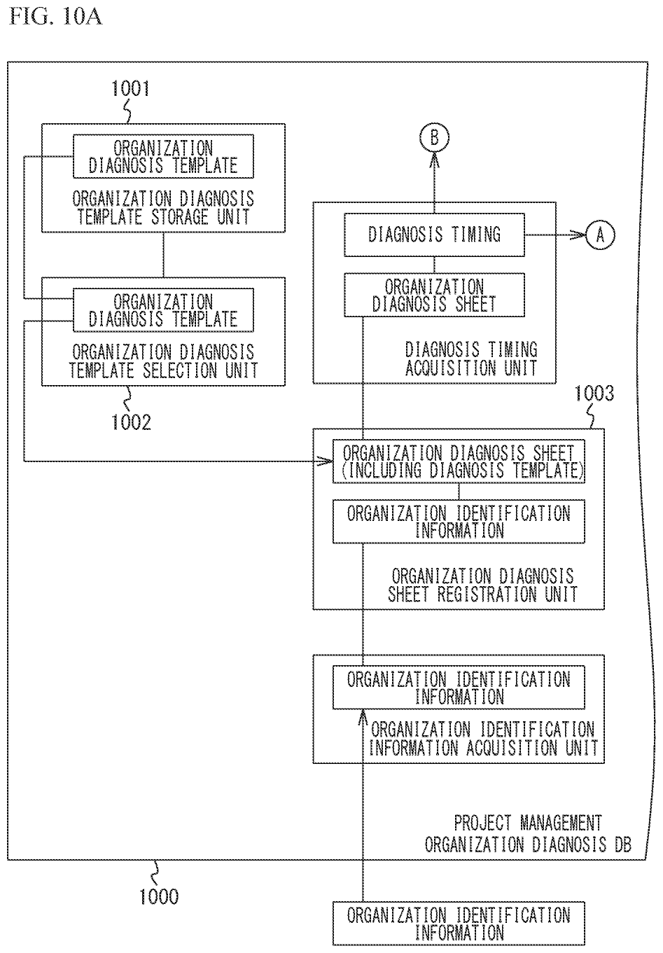

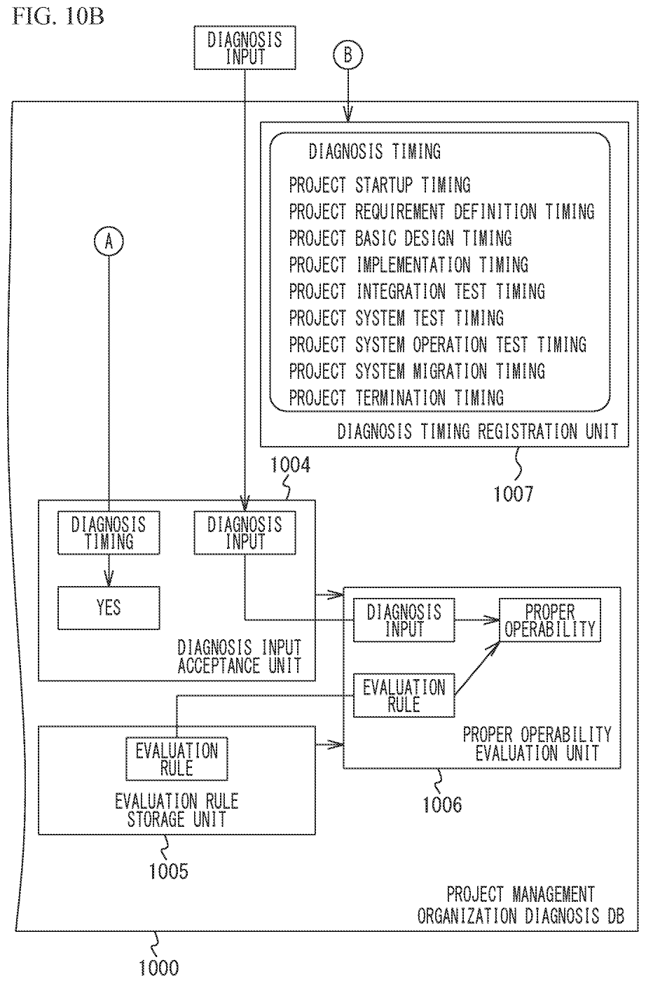

FIGS. 10A and 10B are diagrams illustrating the functional configuration according to the present embodiment. The project management organization diagnosis DB system (1000) of the present embodiment includes an organization diagnosis template storage unit (1001), an organization diagnosis template selection unit (1002), an organization diagnosis sheet registration unit (1003), an organization diagnosis input acceptance unit (1004), an evaluation rule storage unit (1005), and a proper operability evaluation unit (1006) as in the first embodiment, and further has a diagnosis timing registration unit (1007). The description will be made except for the functions already described.

The “diagnosis timing registration unit” has a function of registering at least one timing corresponding to a fiscal year (initial period, half period, end period, etc.) basically adopted by a company as a timing for accepting input of a diagnosis result.

<Hardware Configuration>

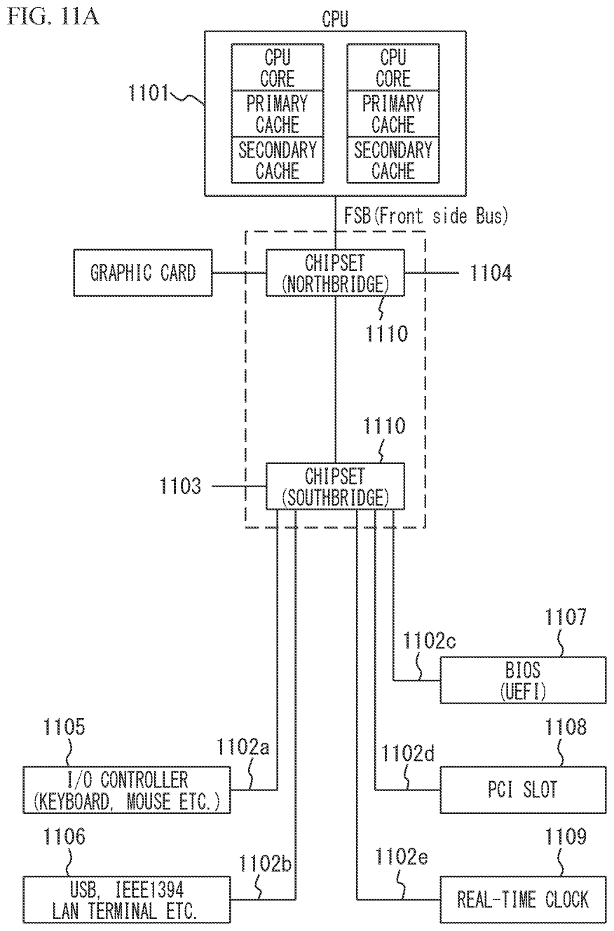

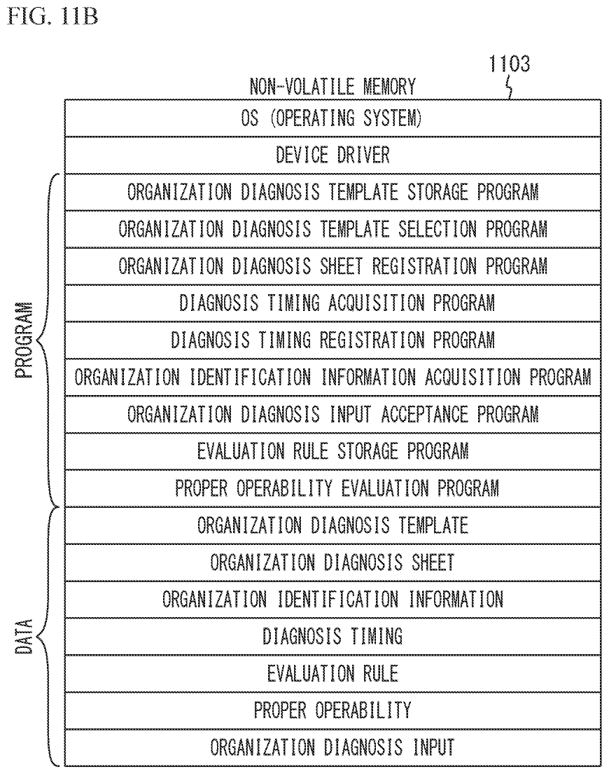

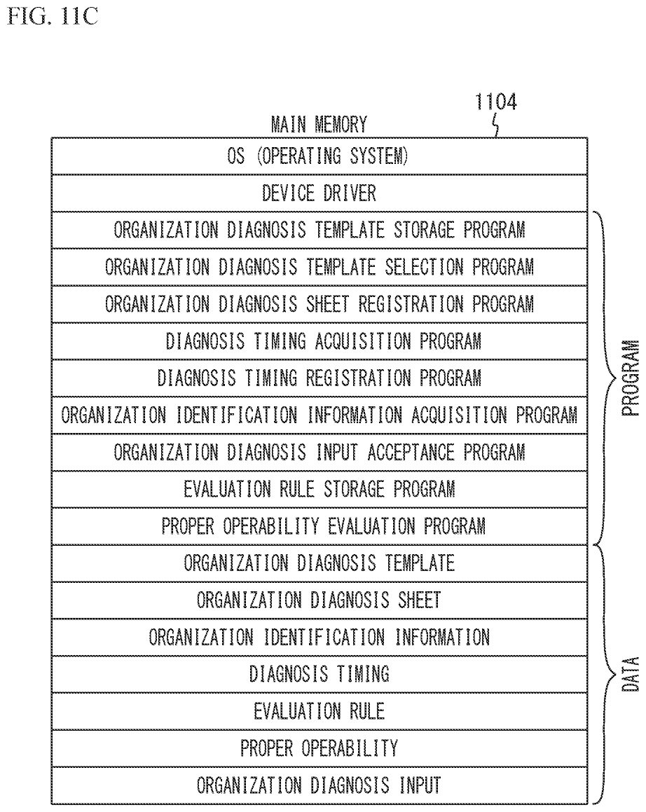

FIGS. 11A to 11C are diagrams illustrating a hardware configuration of the project management organization diagnosis DB system according to the present embodiment. As illustrated in FIGS. 11A to 11C, the computer includes a chip set (1110), a CPU (1101), a non-volatile memory (1103), a main memory (1104), various buses (1102a to 1102e), a BIOS (1107), various interfaces (1105, 1106, 1108), a real-time clock (1109), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 11A to 11C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “diagnosis timing registration program” for registering at least one timing corresponding to the fiscal year (initial period, half period, end period, etc.) basically adopted by the company as the timing for accepting input of the diagnosis result.

<Flow of Processing>

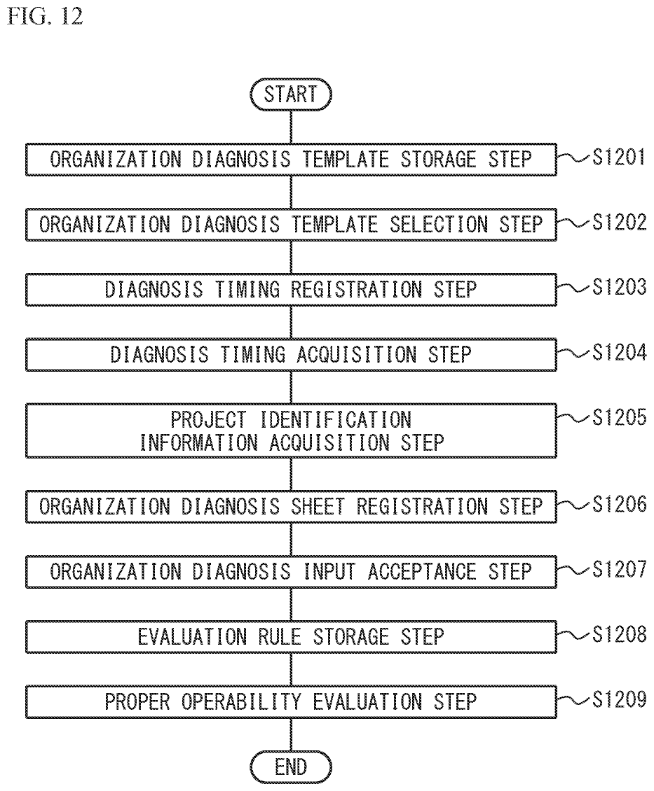

FIG. 12 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S1201), an organization diagnosis template selection step (S1202), a diagnosis timing registration step (S1203), a diagnosis timing acquisition step (S1204), an organization identification information acquisition step (S1205), an organization diagnosis sheet registration step (S1206), an organization diagnosis input acceptance step (S1207), an evaluation rule storage step (S1208), and a proper operability evaluation step (S1209). The steps other than the diagnosis timing registration step are the same as those in the first embodiment.

The “diagnosis timing registration step” is a step of registering at least one timing corresponding to the fiscal year (initial period, half period, end period, etc.) basically adopted by the company as the timing for accepting input of the diagnosis result.

### Fifth Embodiment

In addition to the above-described embodiments, the present embodiment provides a project management organization diagnosis DB system having a function of storing an evaluation result of the proper operability of the project management organization in association with organization identification information.

<Functional Configuration>

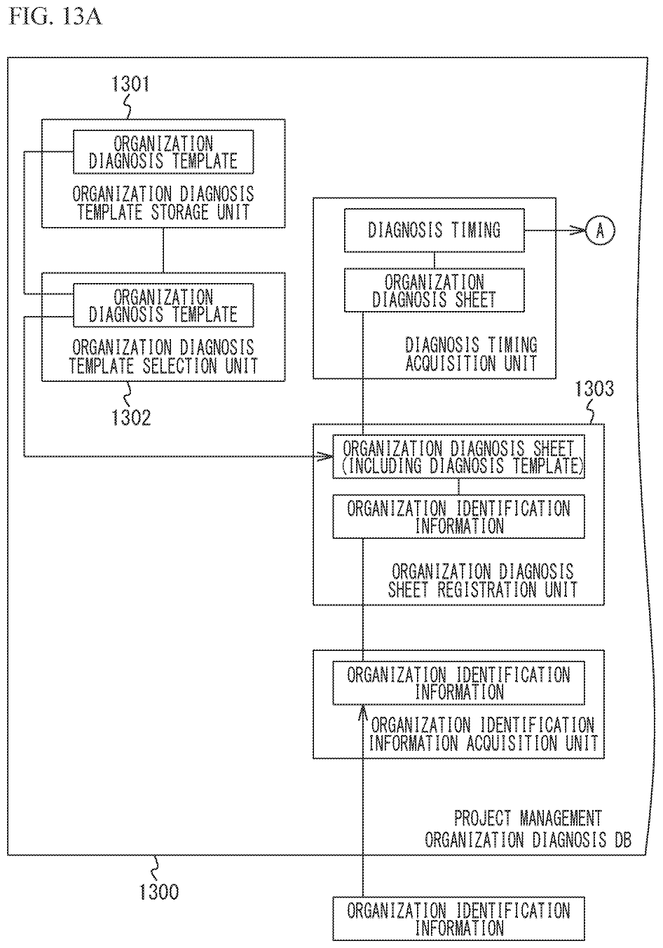

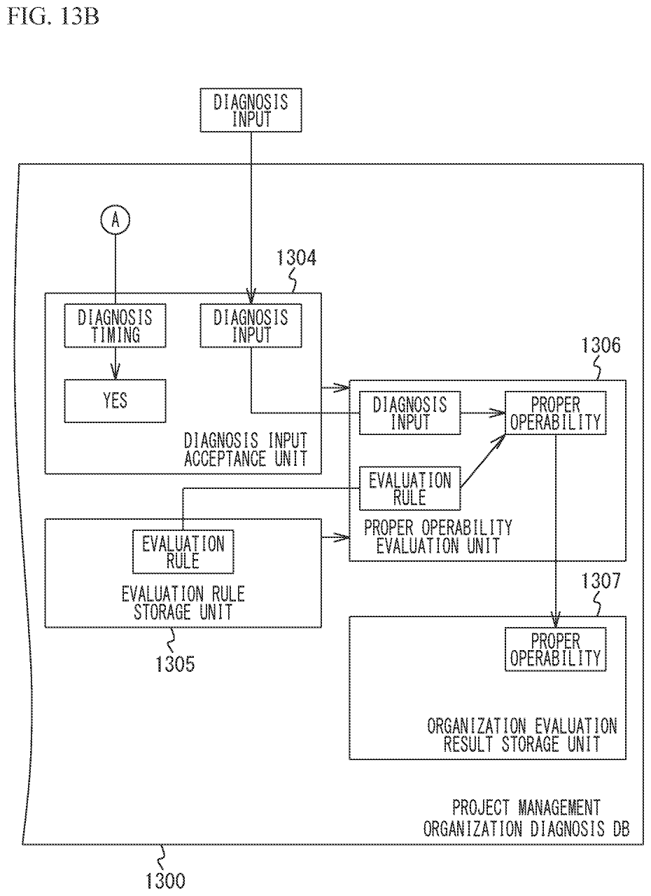

FIGS. 13A and 13B are diagrams illustrating the functional configuration according to the present embodiment. The project management organization diagnosis DB system (1300) of the present embodiment includes an organization diagnosis template storage unit (1301), an organization diagnosis template selection unit (1302), an organization diagnosis sheet registration unit (1003), an organization diagnosis input acceptance unit (1304), an evaluation rule storage unit (1305), and a proper operability evaluation unit (1306) as in the first embodiment, and further has an organization evaluation result storage unit (1307). The description will be made except for the functions already described.

The “organization evaluation result storage unit” has a function of storing the evaluation result of the proper operability of the project management organization in association with the organization identification information.

<Hardware Configuration>

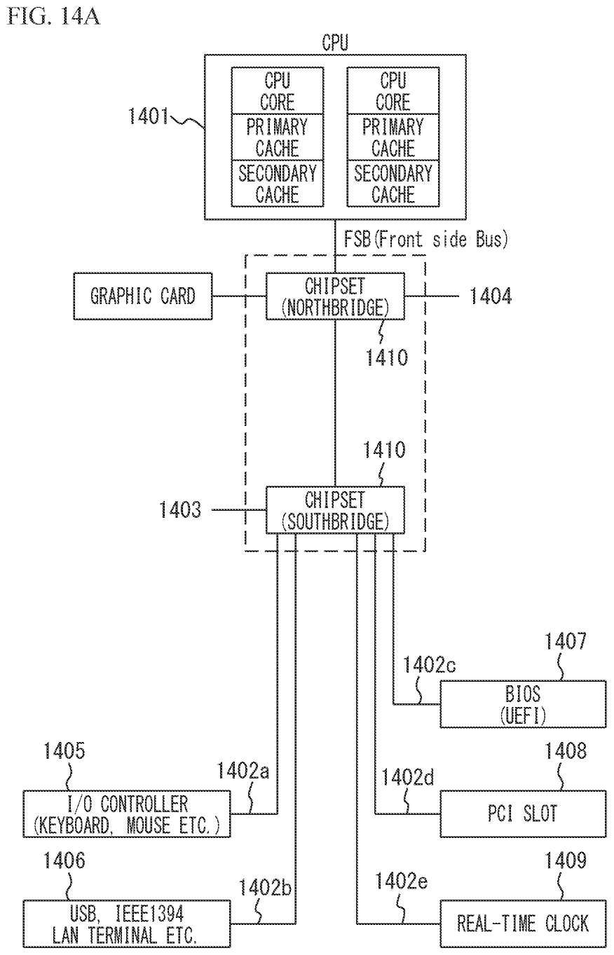

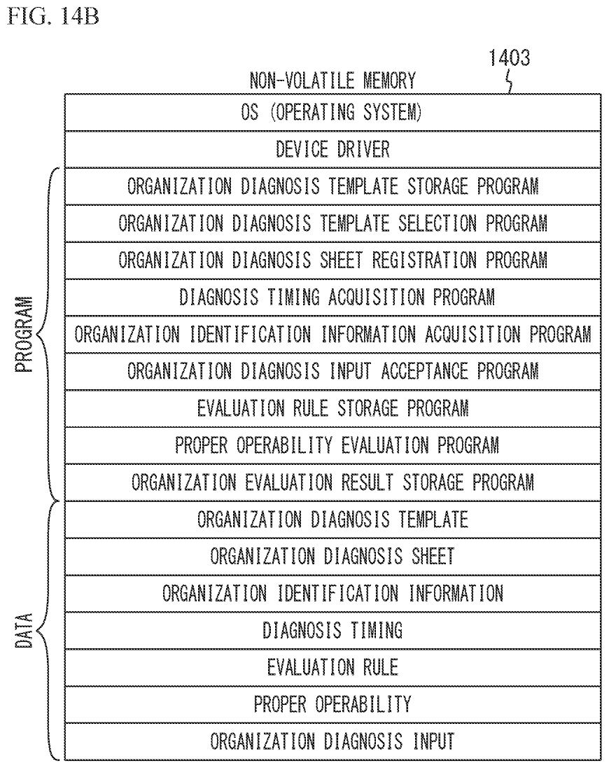

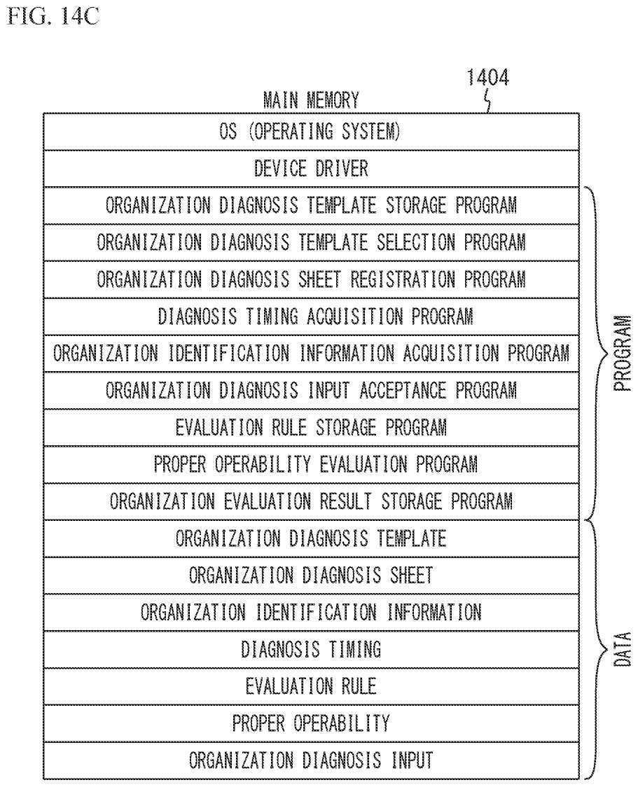

FIGS. 14A to 14C are diagrams illustrating a hardware configuration of the project management organization diagnosis DB system according to the present embodiment. As illustrated in FIGS. 14A to 14C, the computer includes a chip set (1410), a CPU (1401), a non-volatile memory (1403), a main memory (1404), various buses (1402a to 1402e), a BIOS (1407), various interfaces (1405, 1406, 1408), a real-time clock (1409), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 14A to 14C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization evaluation result storage program” for storing the evaluation result of the proper operability of the project management organization in association with the organization identification information.

<Flow of Processing>

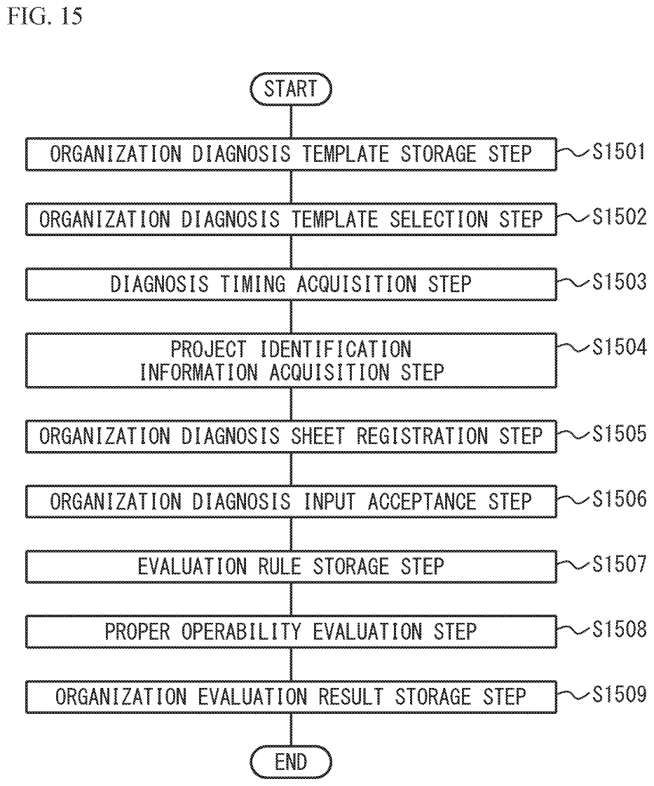

FIG. 15 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S1501), an organization diagnosis template selection step (S1502), a diagnosis timing acquisition step (S1503), an organization identification information acquisition step (S1504), an organization diagnosis sheet registration step (S1505), an organization diagnosis input acceptance step (S1506), an evaluation rule storage step (S1507), a proper operability evaluation step (S1508), and an organization evaluation result storage step (S1509). The steps other than the organization evaluation result storage step are the same as those in the first embodiment.

The “organization evaluation result storage step” is a step of storing the evaluation result of the proper operation of the project management organization in association with the organization identification information.

### Sixth Embodiment

In addition to the above-described embodiments, the present embodiment provides a project management organization diagnosis DB system having a function of searching for an evaluation result of another organization using the evaluation result of the proper operability of the project management organization as a key.

<Functional Configuration>

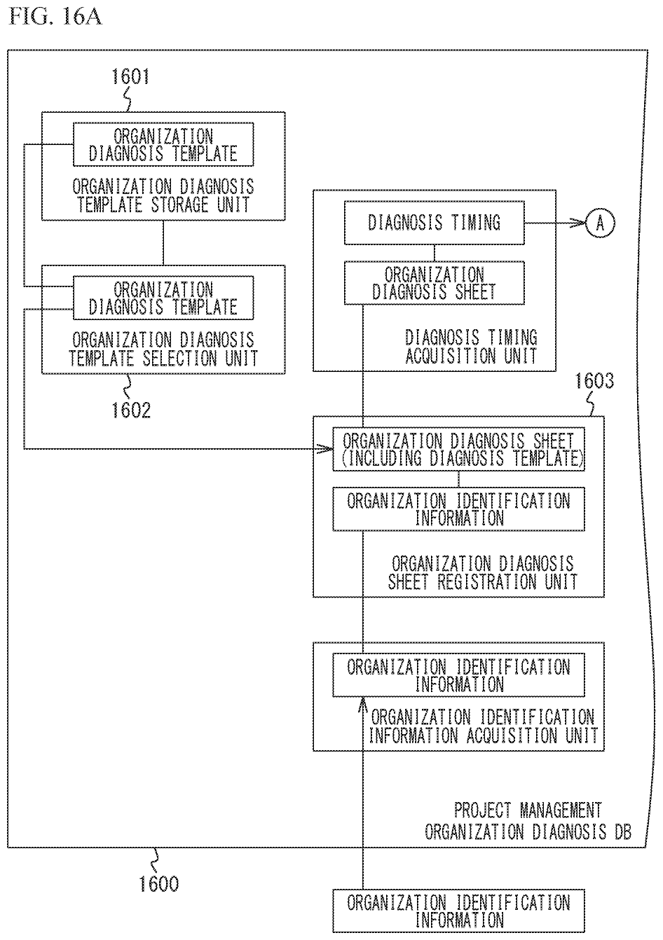

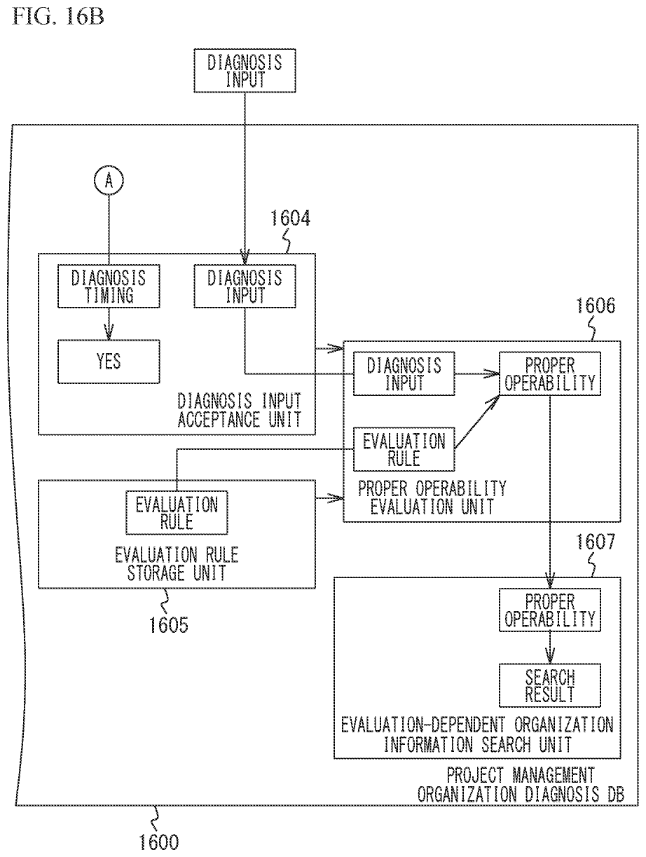

FIGS. 16A and 16B are diagrams illustrating the functional configuration according to the present embodiment. The project management organization diagnosis DB system (1600) of the present embodiment includes an organization diagnosis template storage unit (1601), an organization diagnosis template selection unit (1602), an organization diagnosis sheet registration unit (1603), an organization diagnosis input acceptance unit (1604), an evaluation rule storage unit (1605), and a proper operability evaluation unit (1606) as in the first embodiment, and further has an evaluation-dependent organization information search unit (1307). The description will be made except for the functions already described.

The “evaluation-dependent organization information search unit” has a function of searching for the evaluation result of another organization using the evaluation result of the proper operability of the project management organization as the key. This function is used to search for an evaluation result of another organization that is common to an evaluation result of a certain organization in terms of a phase, a scale, a diagnostician or the like.

<Hardware Configuration>

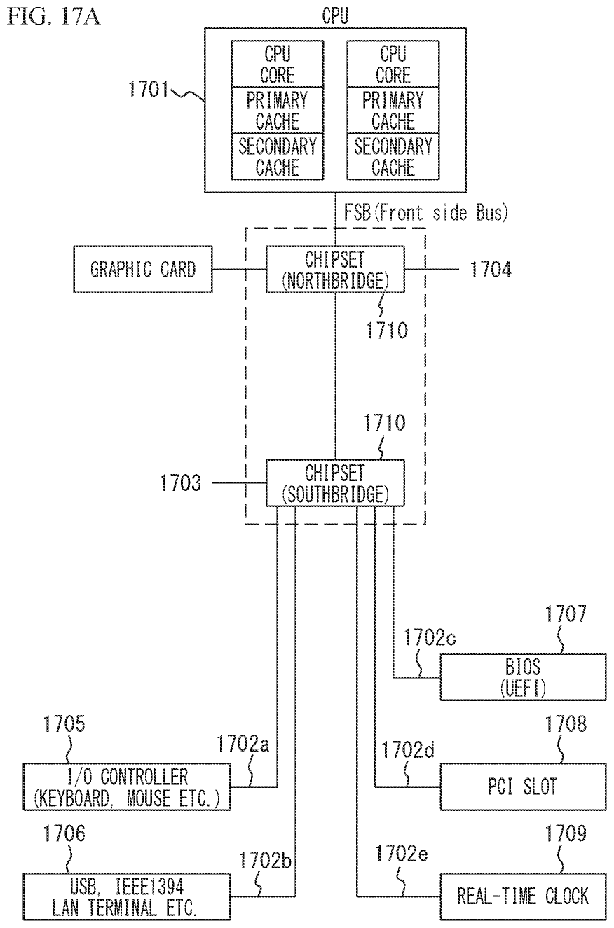

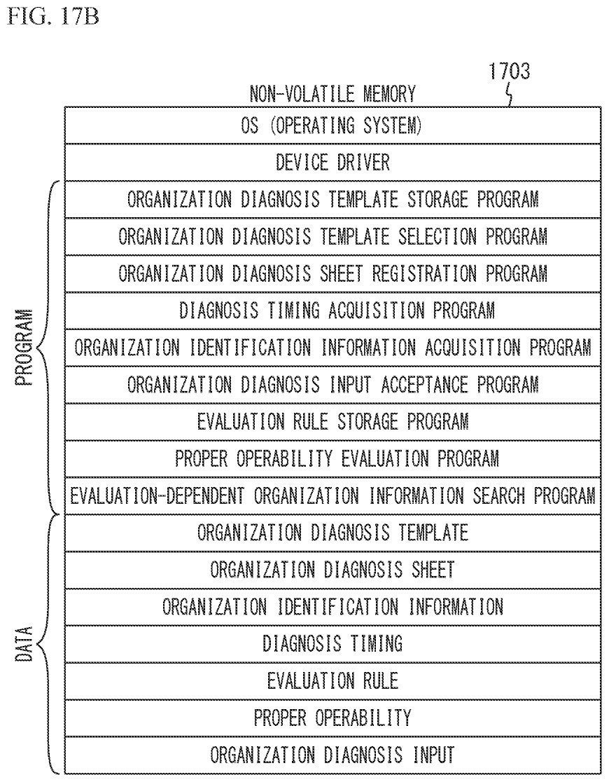

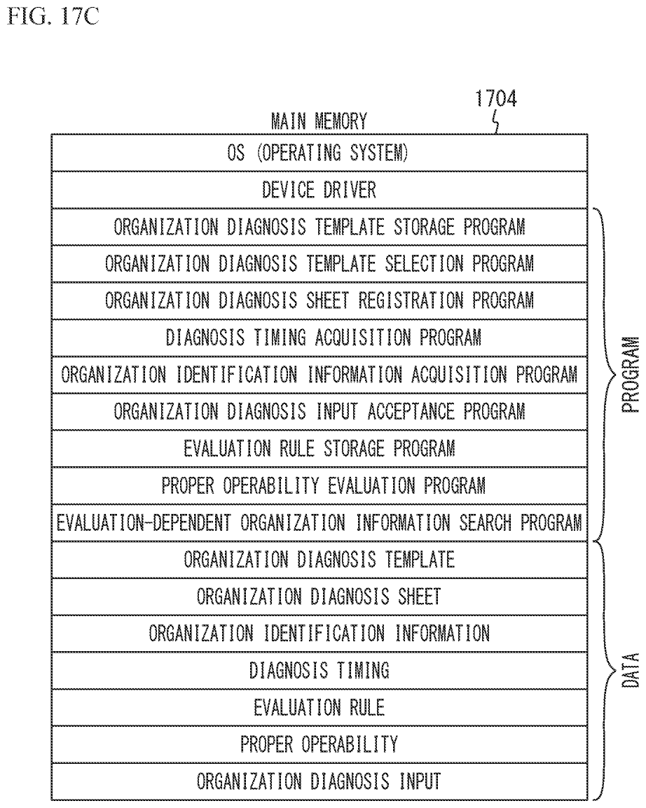

FIGS. 17A to 17C are diagrams illustrating a hardware configuration of the project management organization diagnosis DB system according to the present embodiment. As illustrated in FIGS. 17A to 17C, the computer includes a chip set (1710), a CPU (1701), a non-volatile memory (1703), a main memory (1704), various buses (1702a to 1702e), a BIOS (1707), various interfaces (1705, 1706, 1708), a real-time clock (1709), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 17A to 17C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “evaluation-dependent organization information search program” for searching for the evaluation result of another organization using the evaluation result of the proper operability of the project management organization as the key.

<Flow of Processing>

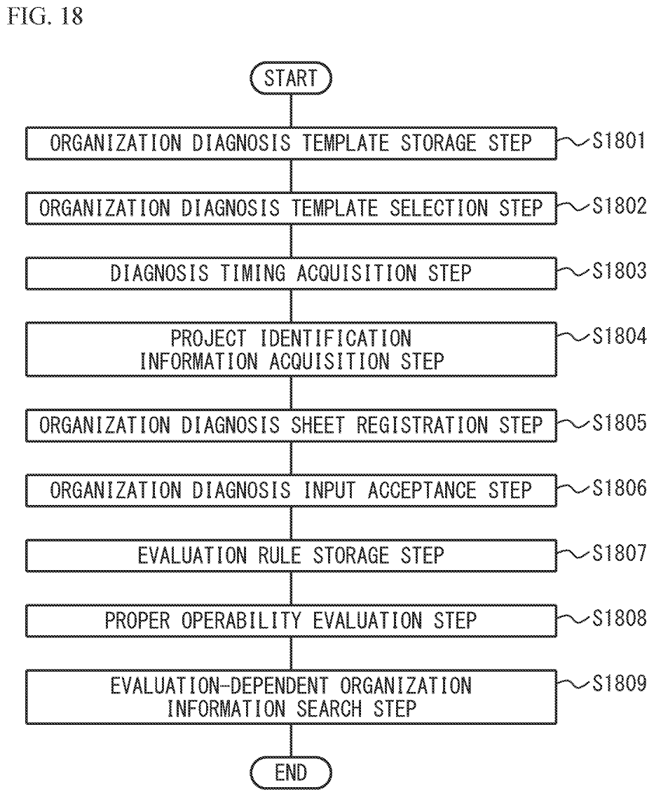

FIG. 18 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S1801), an organization diagnosis template selection step (S1802), a diagnosis timing acquisition step (S1803), an organization identification information acquisition step (S1804), an organization diagnosis sheet registration step (S1805), an organization diagnosis input acceptance step (S1806), an evaluation rule storage step (S1807), a proper operability evaluation step (S1808), and an evaluation-dependent organization information search step (S1809). The steps other than the evaluation-dependent organization information search step are the same as those in the first embodiment.

The “evaluation-dependent organization information search step” is a step of searching for the evaluation result of another organization using the evaluation result of the proper operability of the project management organization as the key.

### Seventh Embodiment

In addition to the above-described embodiments, the present embodiment provides a project management organization diagnosis DB system having a function of searching a stored organization diagnosis sheet.

<Functional Configuration>

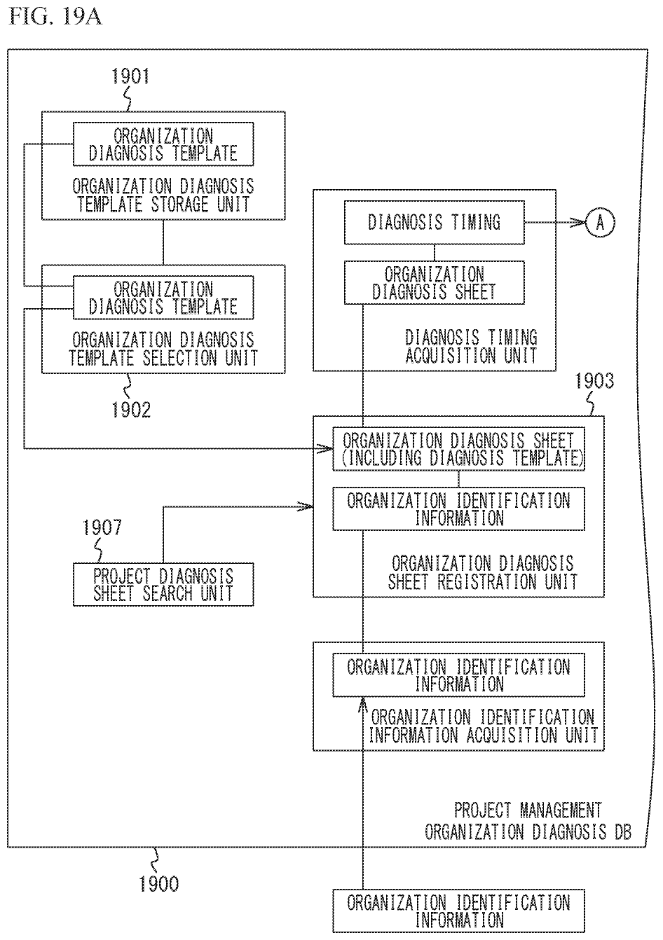

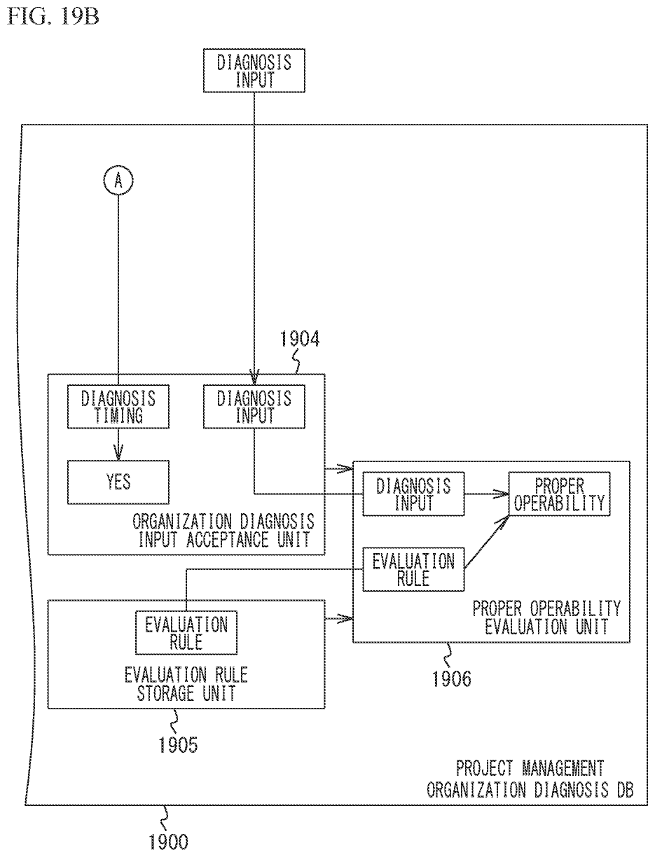

FIGS. 19A and 19B are diagrams illustrating the functional configuration according to the present embodiment. The project management organization diagnosis DB system (1900) of the present embodiment includes an organization diagnosis template storage unit (1901), an organization diagnosis template selection unit (1902), an organization diagnosis sheet registration unit (1903), an organization diagnosis input acceptance unit (1904), an evaluation rule storage unit (1905), and a proper operability evaluation unit (1906) as in the first embodiment, and further has an organization diagnosis sheet search unit (1907). The description will be made except for the functions already described.

The “organization diagnosis sheet search unit” has a function of searching for the stored organization diagnosis sheet. The organization diagnosis sheet search unit may have a diagnostician key search unit for searching for the organization diagnosis sheet using the organization diagnostician identification information as a search key. Further, the organization diagnosis sheet search unit may have an organization diagnosis input key search unit for searching for the organization diagnosis sheet using the organization diagnosis input as the search key.

<Hardware Configuration>

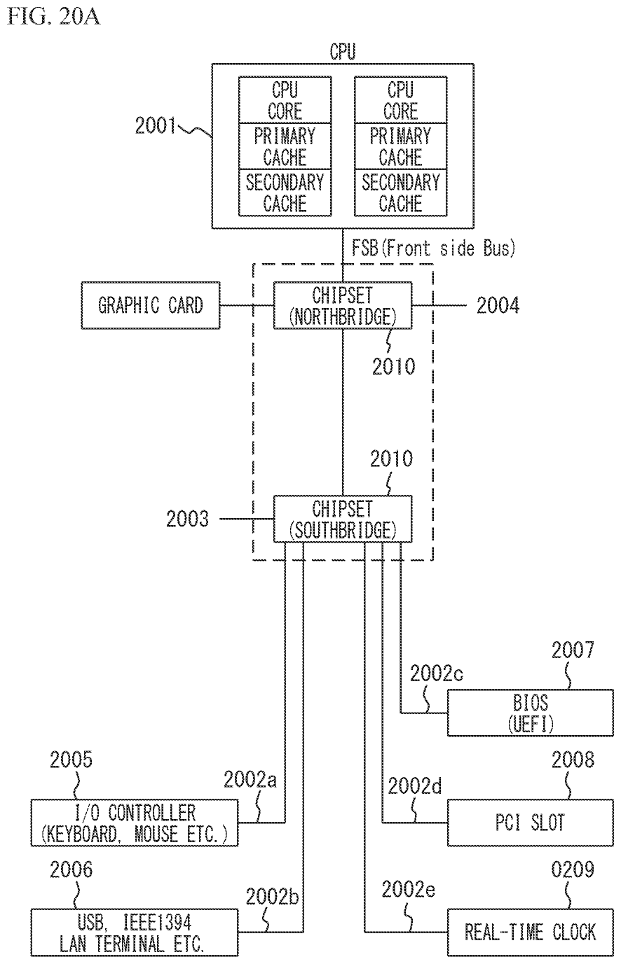

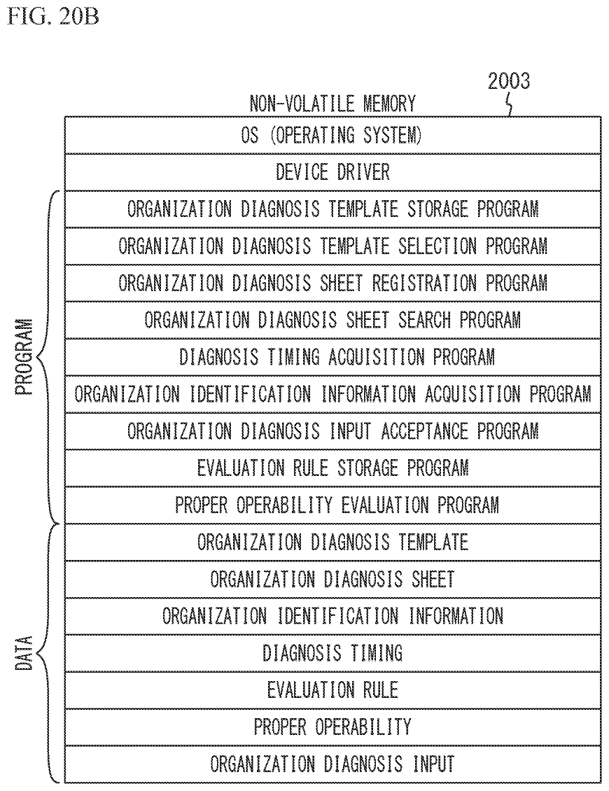

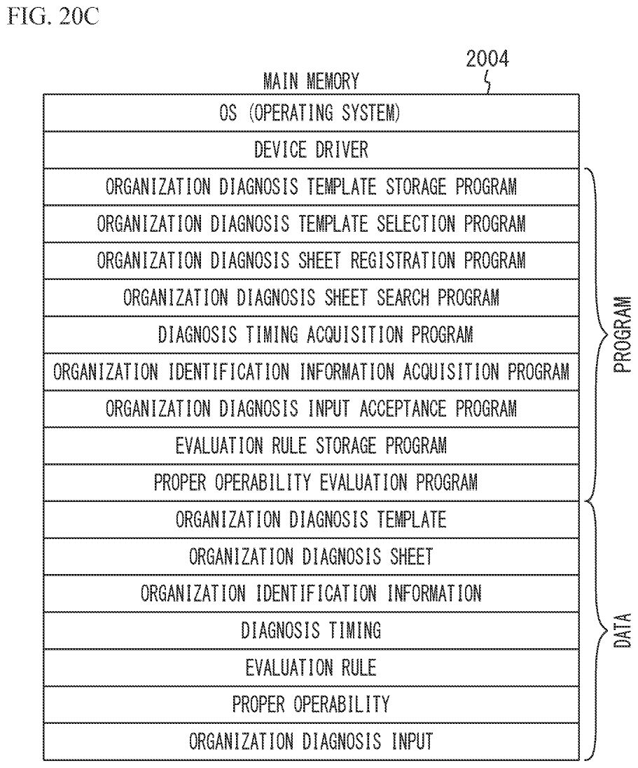

FIGS. 20A to 20C are diagrams illustrating a hardware configuration of the project management organization diagnosis DB system according to the present embodiment. As illustrated in FIGS. 20A to 20C, the computer includes a chip set (2010), a CPU (2001), a non-volatile memory (2003), a main memory (2004), various buses (2002a to 2002e), a BIOS (2007), various interfaces (2005, 2006, 2008), a real-time clock (2009), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 20A to 20C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis sheet search program” for searching for the stored organization diagnosis sheet.

<Flow of Processing>

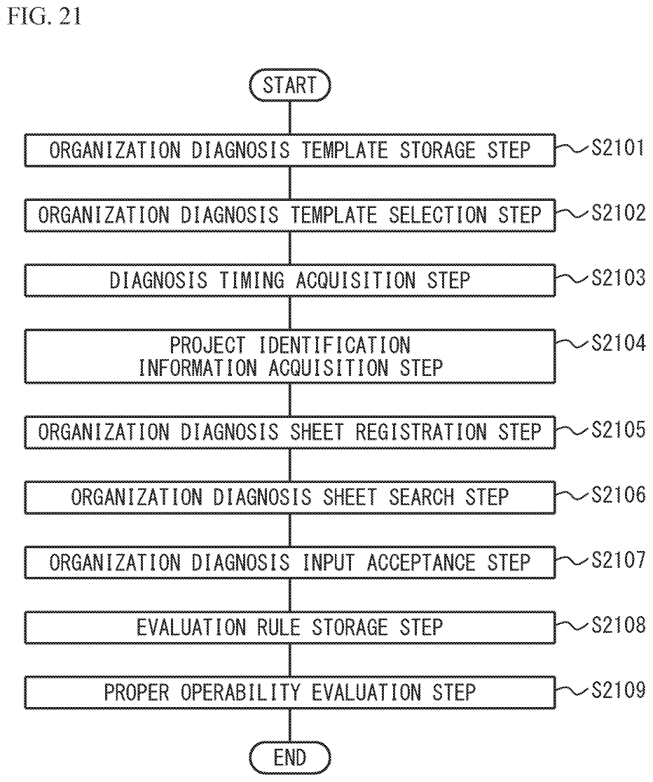

FIG. 21 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S2101), an organization diagnosis template selection step (S2102), a diagnosis timing acquisition step (S2103), an organization identification information acquisition step (S2104), an organization diagnosis sheet registration step (S2105), an organization diagnosis sheet search step (S2106), an organization diagnosis input acceptance step (S1807), an evaluation rule storage step (S1808), and a proper operability evaluation step (S1809). The steps other than the organization diagnosis sheet search step are the same as those in the first embodiment.

The “organization diagnosis sheet search step” is a step of searching for the stored organization diagnosis sheet.

### Eighth Embodiment

In addition to the above-described embodiments, the present embodiment provides a project management organization diagnosis DB system having a function of comparing organization diagnosis sheets with each other.

<Functional Configuration>

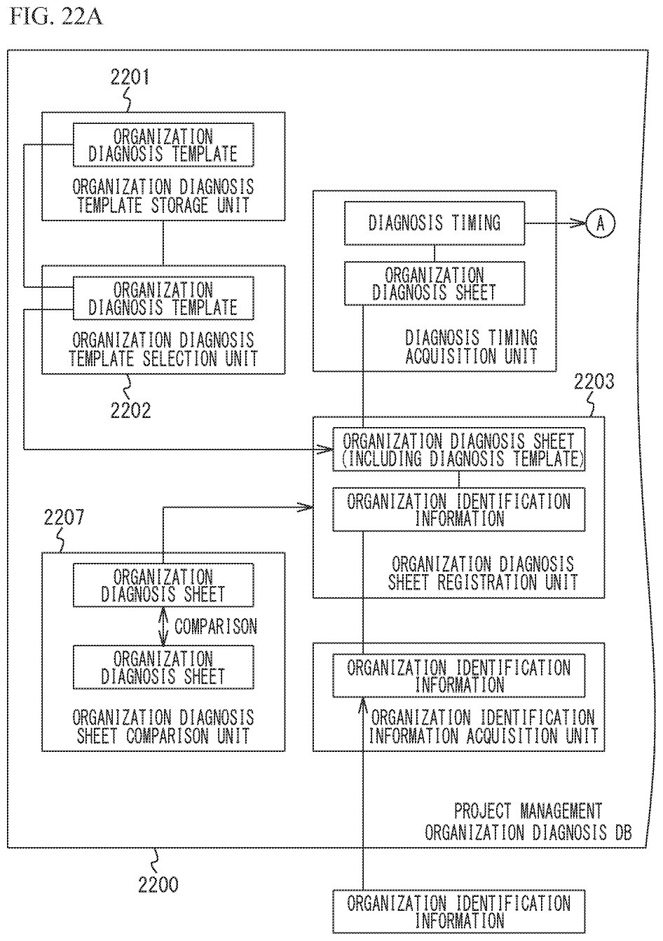

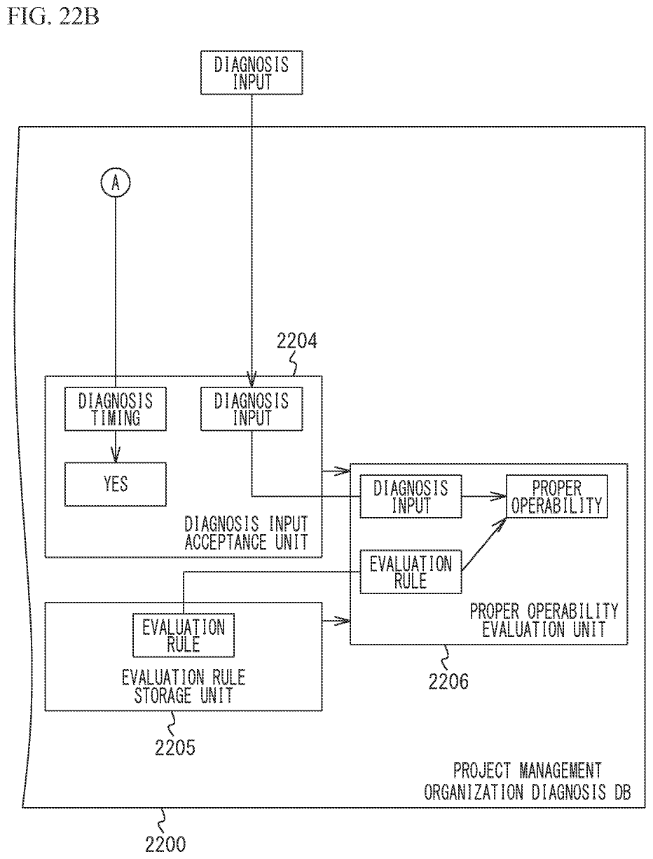

FIGS. 22A and 22B are diagrams illustrating the functional configuration according to the present embodiment. The project management organization diagnosis DB system (2200) of the present embodiment includes an organization diagnosis template storage unit (2201), an organization diagnosis template selection unit (2202), an organization diagnosis sheet registration unit (2203), an organization diagnosis input acceptance unit (2204), an evaluation rule storage unit (2205), and a proper operability evaluation unit (2206) as in the first embodiment, and further has an organization diagnosis sheet comparison unit (2207). The description will be made except for the functions already described.

The “organization diagnosis sheet comparison unit” has a function of comparing the organization diagnosis sheets with each other. The organization diagnosis sheet comparison unit may have an organization diagnosis sheet comparison unit with organization diagnosis input for comparing organization diagnosis sheets having the organization diagnosis inputs with each other. For example, the organization diagnosis sheet comparison unit may have an inter-diagnosticians organization diagnosis sheet comparison unit for comparing different organization diagnosis sheets having organization diagnosis inputs among a plurality of organization diagnosticians. Further, the organization diagnosis sheet comparison unit may have a common item organization diagnosis sheet comparison unit for comparing the organization diagnosis sheets with one or more of the same knowledge area, the same organization management type, and the same diagnosis item among a plurality of organization diagnosis sheets having the organization diagnosis inputs. Further, the organization diagnosis sheet comparison unit may have an average comparison output unit for outputting a comparison result using an average value of organization diagnosis inputs of a plurality of organization diagnosis sheets. Further, the organization diagnosis sheet comparison unit may have an organization diagnosis sheet comparer for calculating an average value for each industry, each type of industry, or each type of project based on accumulated diagnosis result information of a plurality of organization diagnoses, and setting target values classified into a high level target value, a standard target value, and a low level target value.

<Hardware Configuration>

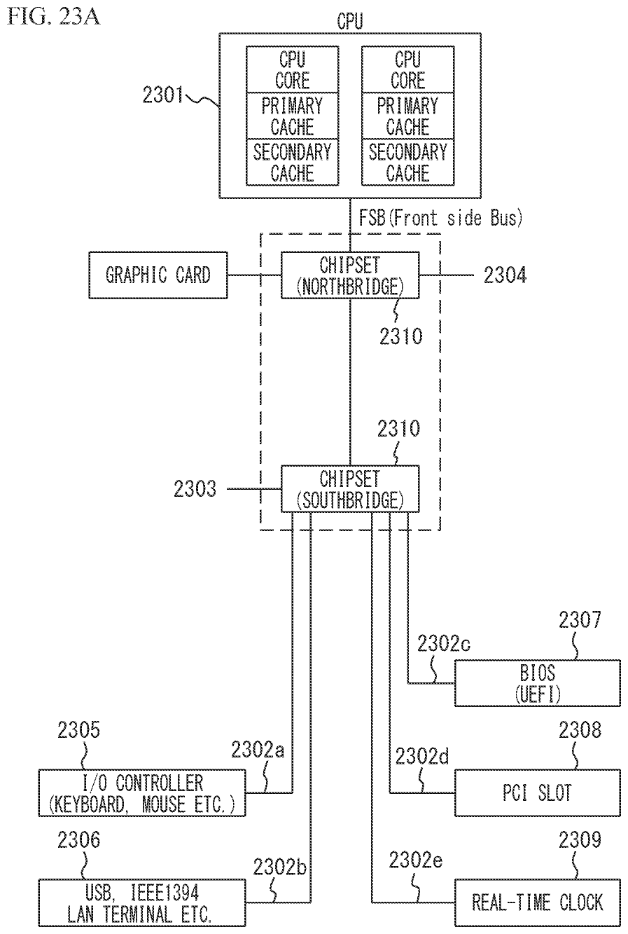

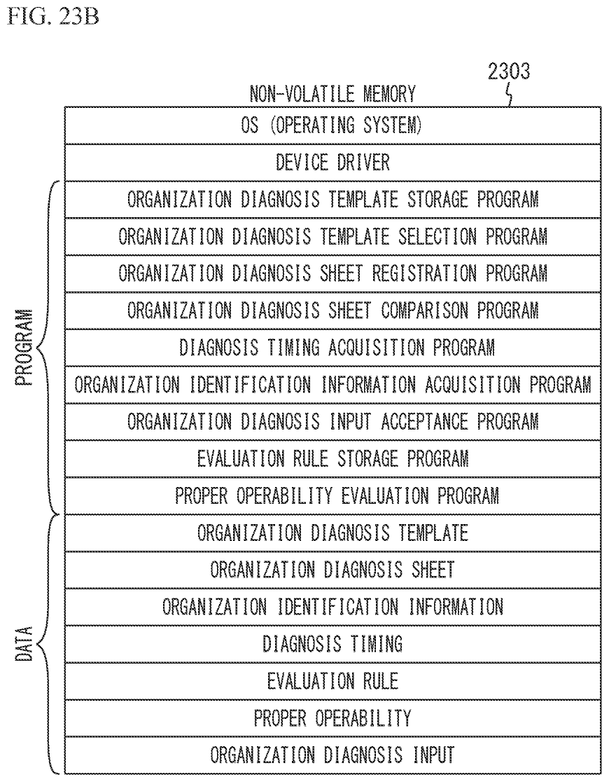

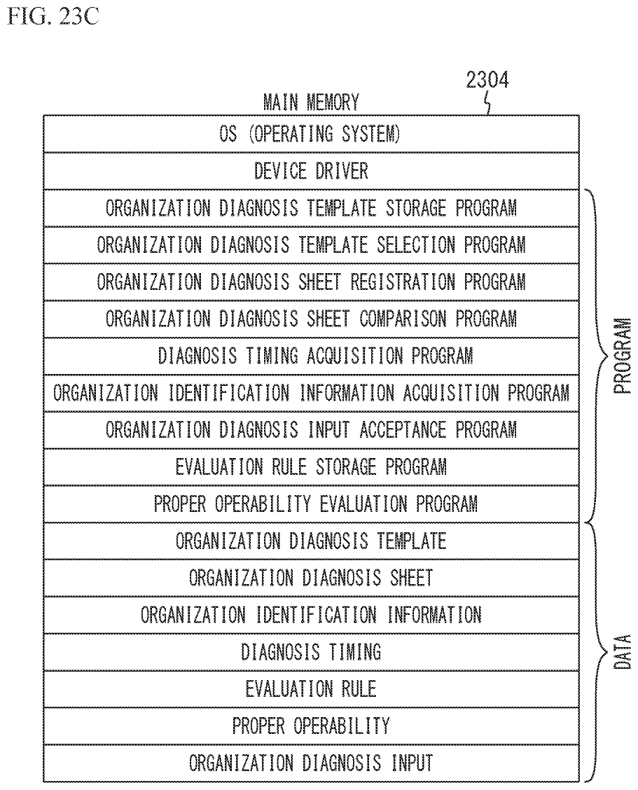

FIGS. 23A to 23C are diagrams illustrating a hardware configuration of the project management organization diagnosis DB system according to the present embodiment. As illustrated in FIGS. 23A to 23C, the computer includes a chip set (2310), a CPU (2301), a non-volatile memory (2303), a main memory (2304), various buses (2302a to 2302e), a BIOS (2307), various interfaces (2305, 2306, 2308), a real-time clock (2309), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 23A to 23C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis sheet comparison program” for comparing the organization diagnosis sheets with each other.

<Flow of Processing>

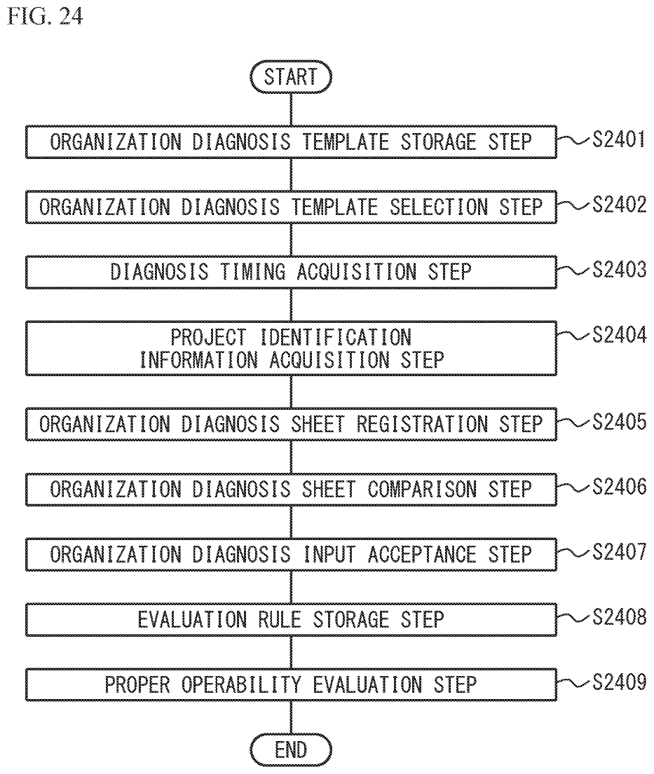

FIG. 24 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S2401), an organization diagnosis template selection step (S2402), a diagnosis timing acquisition step (S2403), an organization identification information acquisition step (S2404), an organization diagnosis sheet registration step (S2405), an organization diagnosis sheet comparison step (S2406), an organization diagnosis input acceptance step (S2407), an evaluation rule storage step (S2408), and a proper operability evaluation step (S2409). The steps other than the organization diagnosis sheet comparison step are the same as those in the first embodiment.

The “organization diagnosis sheet comparison step” is a step of comparing organization diagnosis sheets with each other.

### Ninth Embodiment

In addition to the above-described embodiments, this embodiment provides a project management organization diagnosis DB system having a function of acquiring an input status of an organization diagnosis input, and a function of outputting the acquired organization diagnosis input status.

<Functional Configuration>

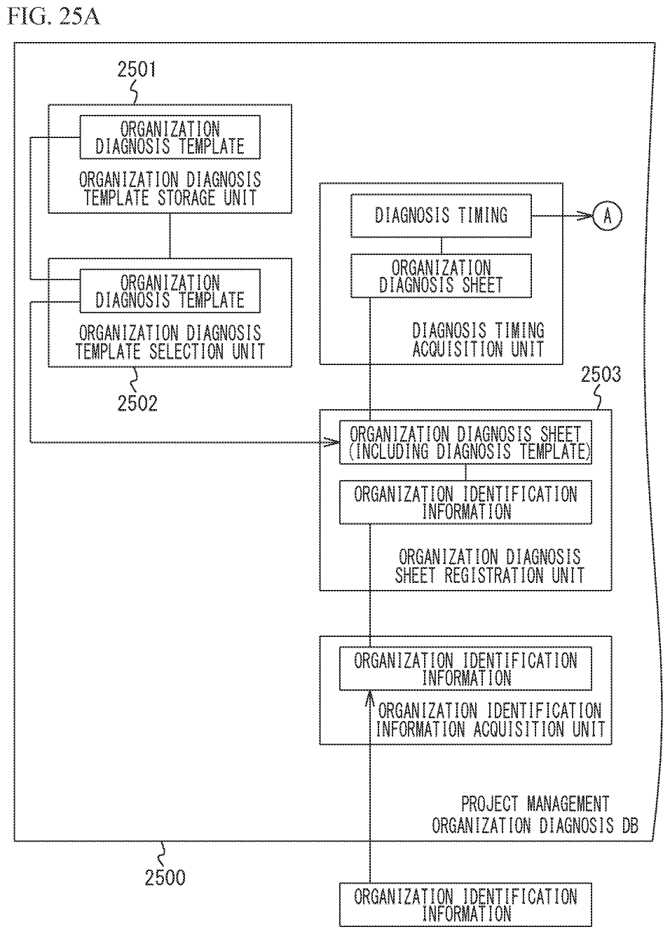

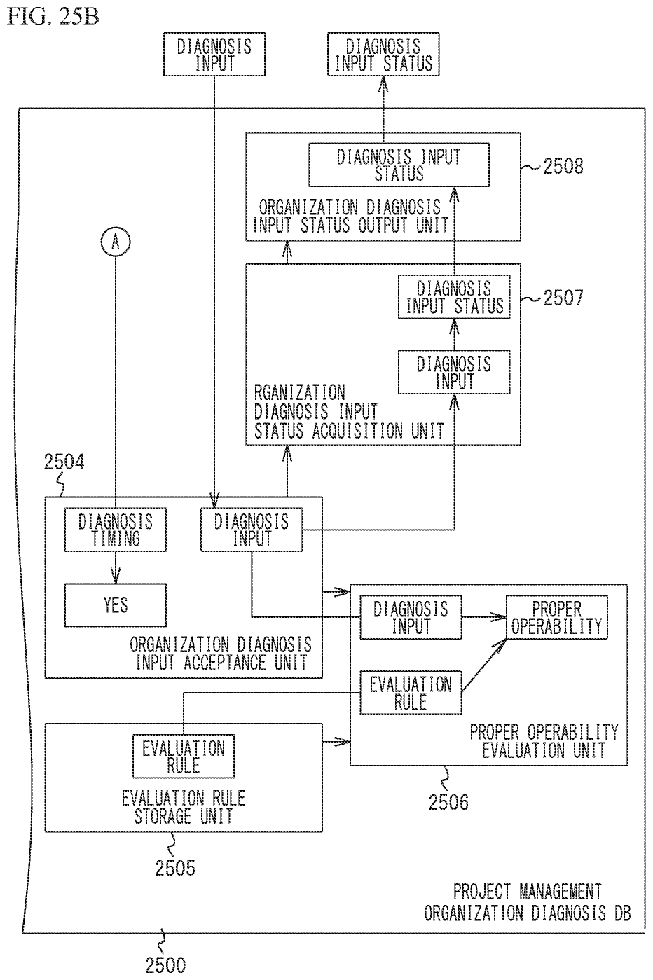

FIGS. 25A and 25B are diagrams illustrating the functional configuration according to the present embodiment. The project management organization diagnosis DB system (2500) of the present embodiment includes an organization diagnosis template storage unit (2501), an organization diagnosis template selection unit (2502), an organization diagnosis sheet registration unit (2503), an organization diagnosis input acceptance unit (2504), an evaluation rule storage unit (2505), and a proper operability evaluation unit (2506) as in the first embodiment, and further has an organization diagnosis input status acquisition unit (2507) and an organization diagnosis input status output unit (2508). The description will be made except for the functions already described.

The “organization diagnosis input status acquisition unit” has a function of acquiring an input status of the organization diagnosis input.

The “organization diagnosis input status output unit” has a function of outputting the acquired organization diagnosis input status.

<Hardware Configuration>

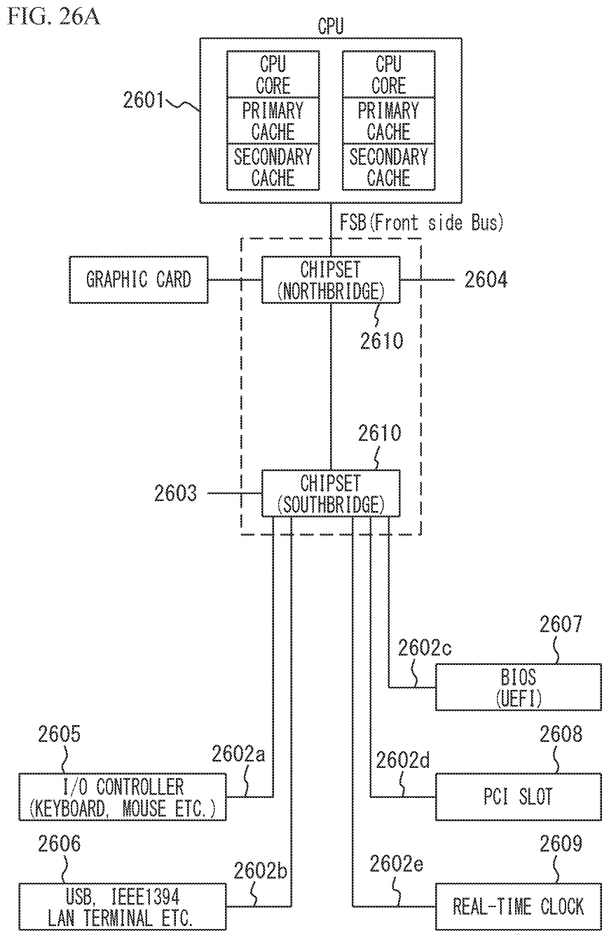

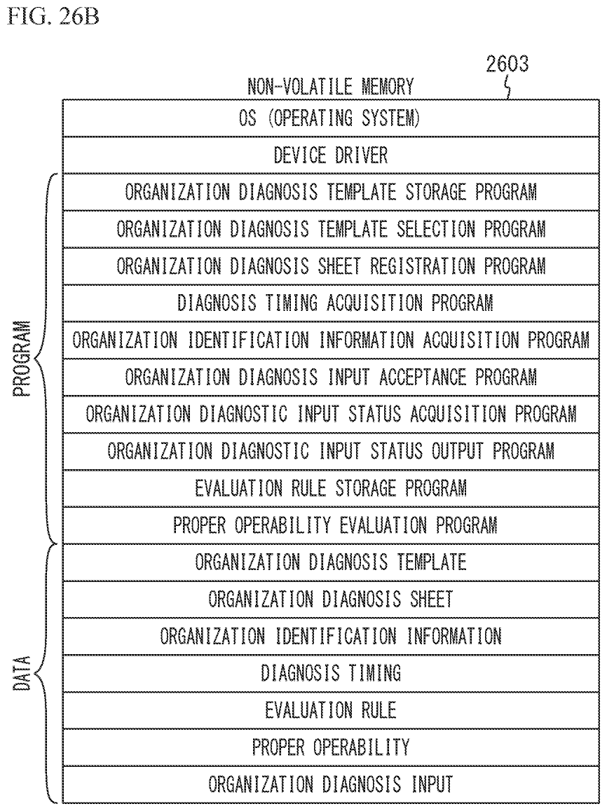

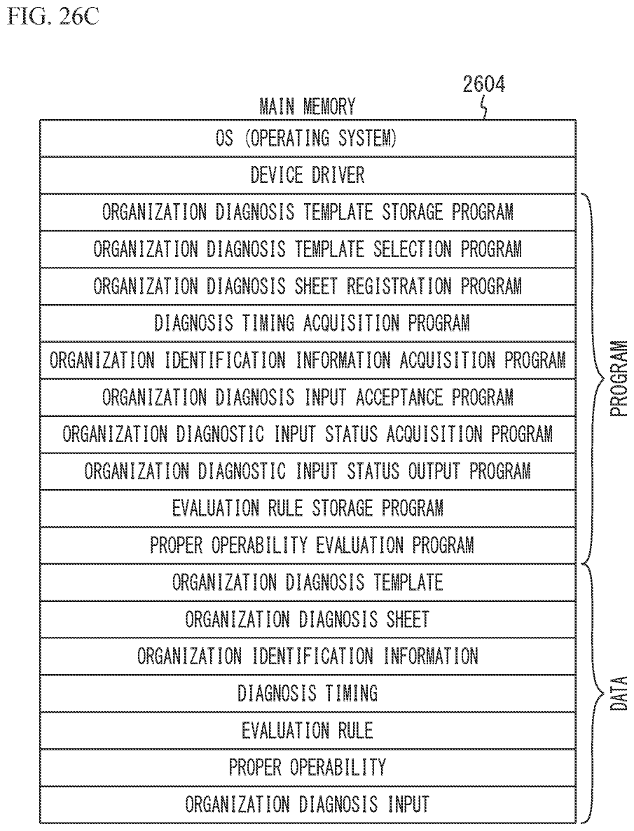

FIGS. 26A to 26C are diagrams illustrating a hardware configuration of the project management organization diagnosis DB system according to the present embodiment. As illustrated in FIGS. 26A to 26C, the computer includes a chip set (2610), a CPU (2601), a non-volatile memory (2603), a main memory (2604), various buses (2602a to 2602e), a BIOS (2607), various interfaces (2605, 2606, 2608), a real-time clock (2609), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 26A to 26C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis input status acquisition program” for acquiring the input status of the organization diagnosis input and an “organization diagnosis input status output program” for outputting the acquired organization diagnosis input status.

<Flow of Processing>

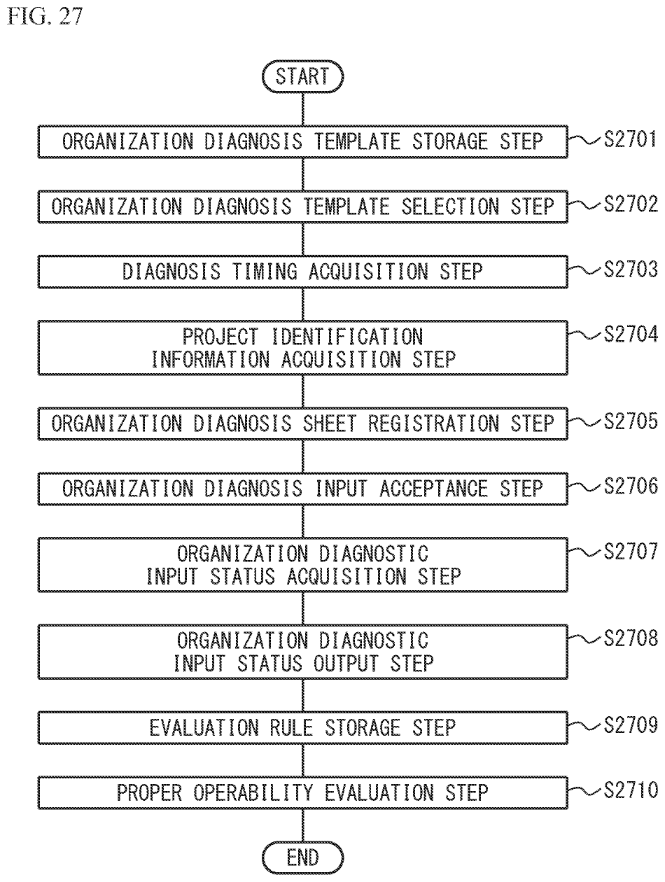

FIG. 27 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S2701), an organization diagnosis template selection step (S2702), a diagnosis timing acquisition step (S2703), an organization identification information acquisition step (S2704), an organization diagnosis sheet registration step (S2705), an organization diagnosis input acceptance step (S2706), an organization diagnosis input status acquisition step (S2707), an organization diagnosis input status output step (S2708), an evaluation rule storage step (S2709), and a proper operability evaluation step (S2710). The steps other than the organization diagnosis input status acquisition step and the organization diagnosis input status output step are the same as those in the first embodiment.

The “organization diagnosis input status acquisition step” is a step of acquiring the input status of the organization diagnosis input.

The “organization diagnosis input status output step” is a step of outputting the acquired organization diagnosis input status.

### Tenth Embodiment

In addition to the above-described embodiments, the present embodiment provides a project management organization diagnosis DB system having a function of searching for an organization diagnosis template stored in an organization diagnosis template storage unit.

<Functional Configuration>

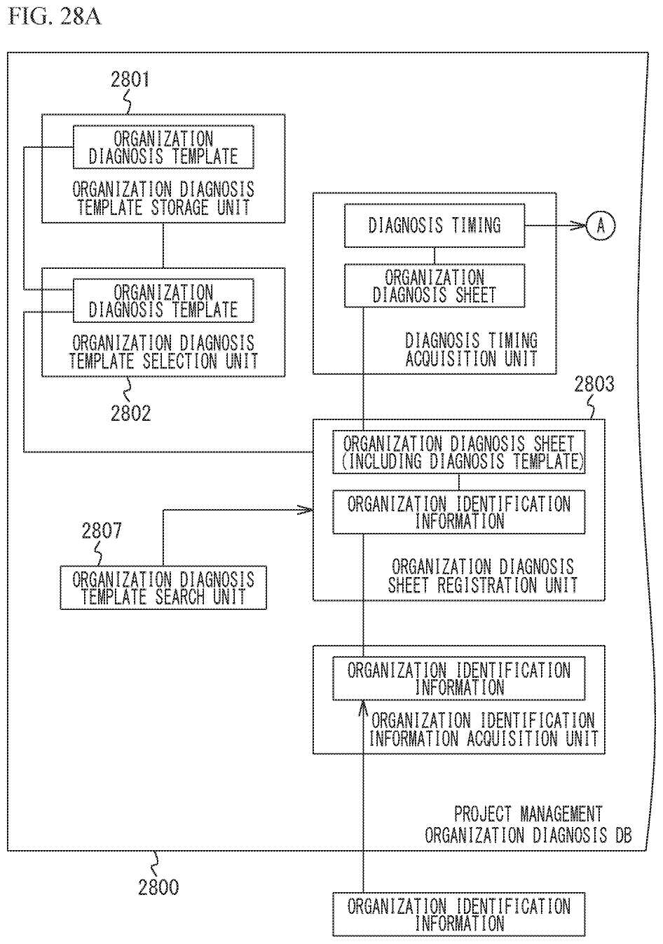

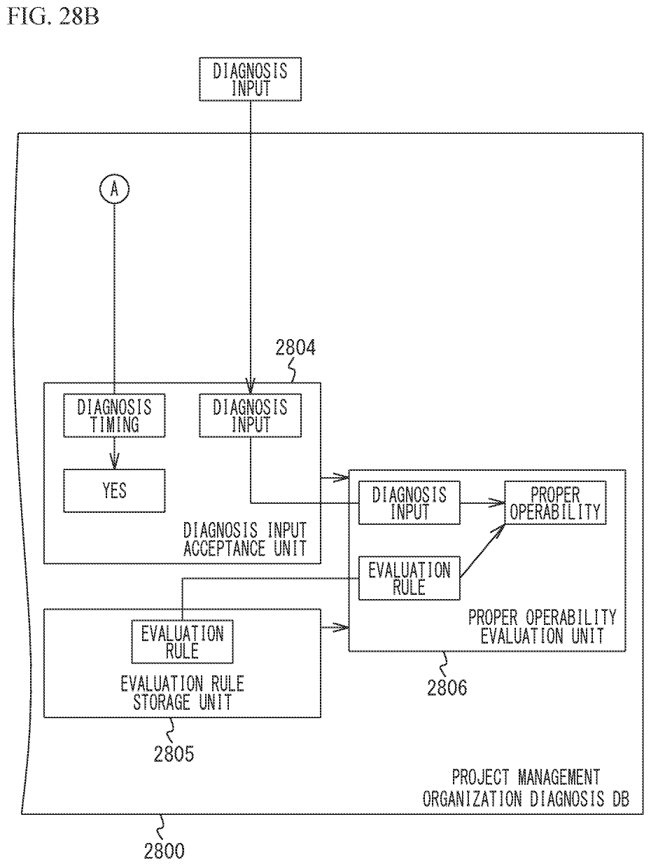

FIGS. 28A and 28B are diagrams illustrating the functional configuration according to the present embodiment. The project management organization diagnosis DB system (2800) of the present embodiment includes an organization diagnosis template storage unit (2801), an organization diagnosis template selection unit (2802), an organization diagnosis sheet registration unit (2803), an organization diagnosis input acceptance unit (2804), an evaluation rule storage unit (2805), and a proper operability evaluation unit (2806) as in the first embodiment, and further has an organization diagnosis template search unit (2807). The description will be made except for the functions already described.

The “organization diagnosis template search unit” has a function of searching for the organization diagnosis template stored in the organization diagnosis template storage unit.

<Hardware Configuration>

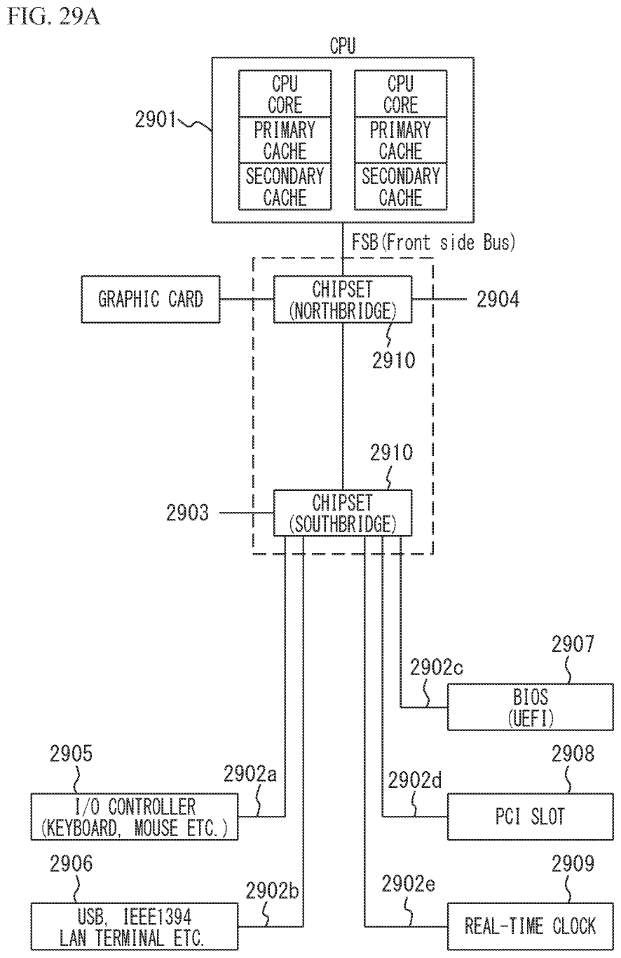

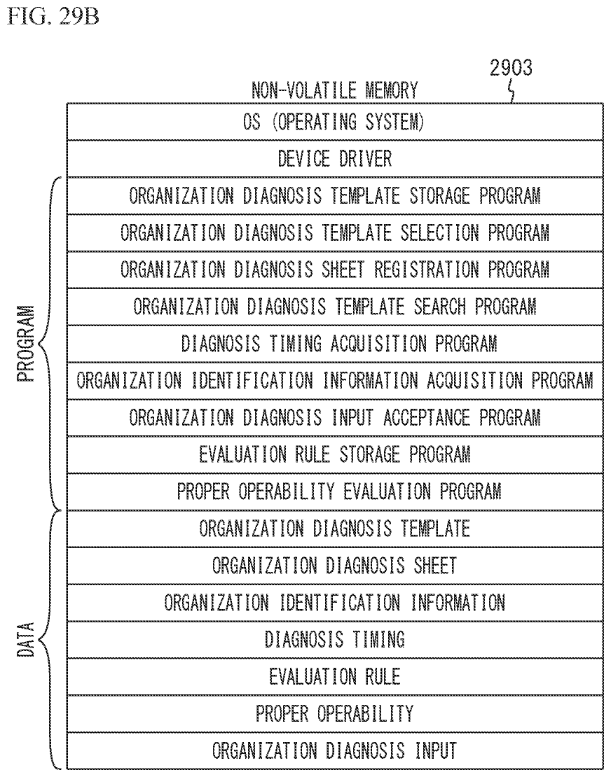

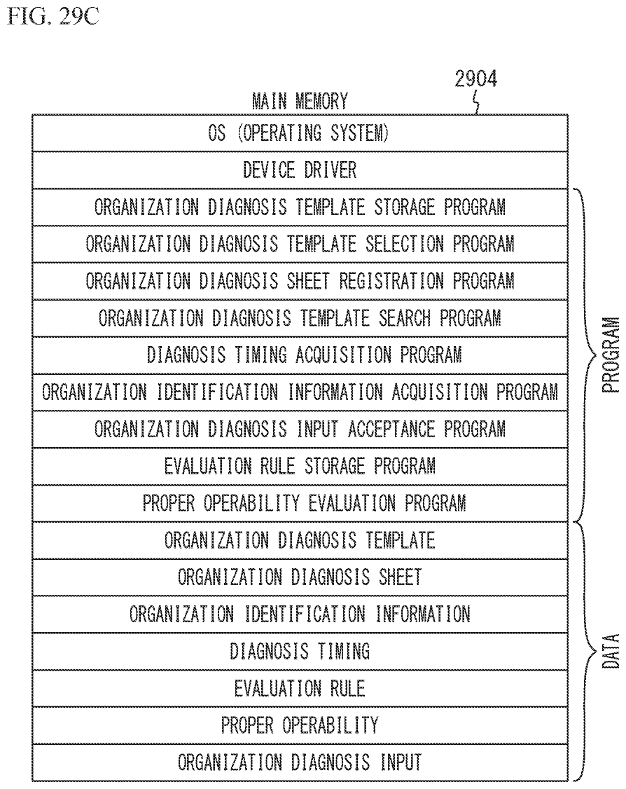

FIGS. 29A to 29C are diagrams illustrating a hardware configuration of the project management organization diagnosis DB system according to the present embodiment. As illustrated in FIGS. 29A to 29C, the computer includes a chip set (2910), a CPU (2901), a non-volatile memory (2903), a main memory (2904), various buses (2902a to 2902e), a BIOS (2907), various interfaces (2905, 2906, 2908), a real-time clock (2909), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 29A to 29C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis template search program” for searching for the organization diagnosis template stored in the organization diagnosis template storage unit.

<Flow of Processing>

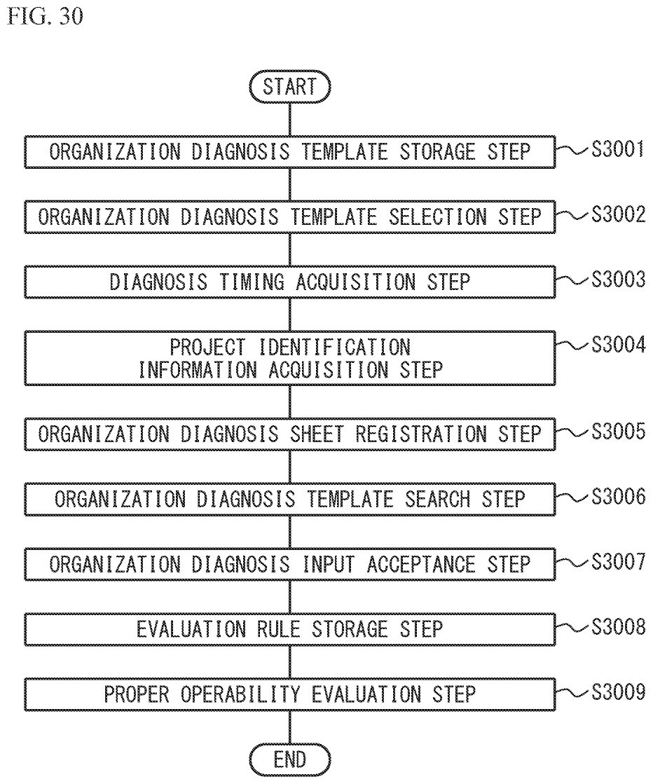

FIG. 30 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S3001), an organization diagnosis template selection step (S3002), a diagnosis timing acquisition step (S3003), an organization identification information acquisition step (S3004), an organization diagnosis sheet registration step (S3005), an organization diagnosis template search step (S3006), an organization diagnosis input acceptance step (S3007), an evaluation rule storage step (S3008), and a proper operability evaluation step (S3009). The steps other than the organization diagnosis template search step are the same as those in the first embodiment.

The “organization diagnosis template search step” is a step of searching for the organization diagnosis template stored in the organization diagnosis template storage unit.

### Eleventh Embodiment

In addition to the above-described embodiments, the present embodiment provides a project management organization diagnosis DB system having a function of managing the organization diagnosis template.

<Functional Configuration>

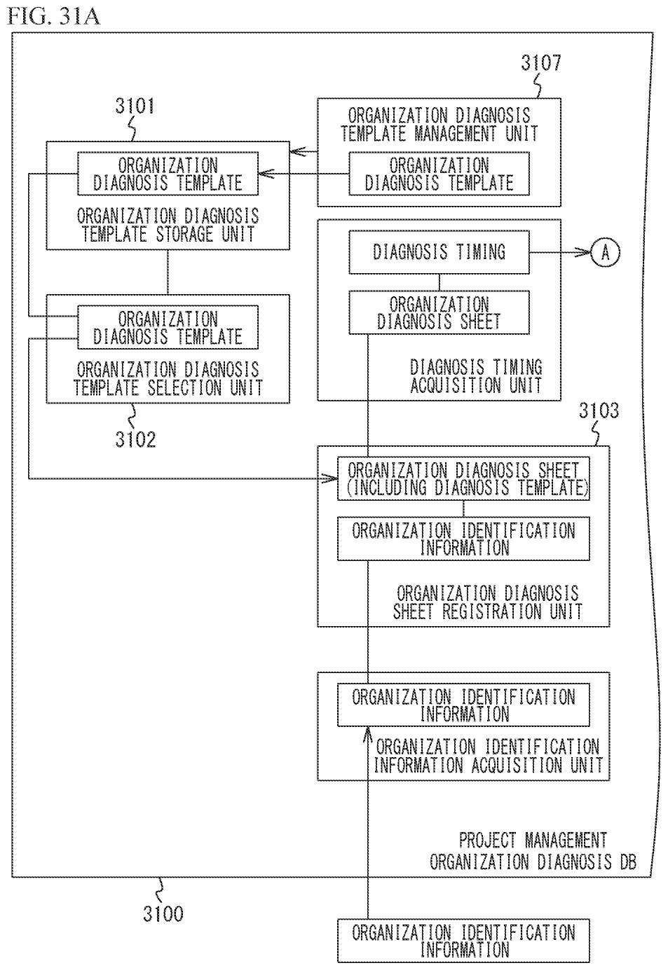

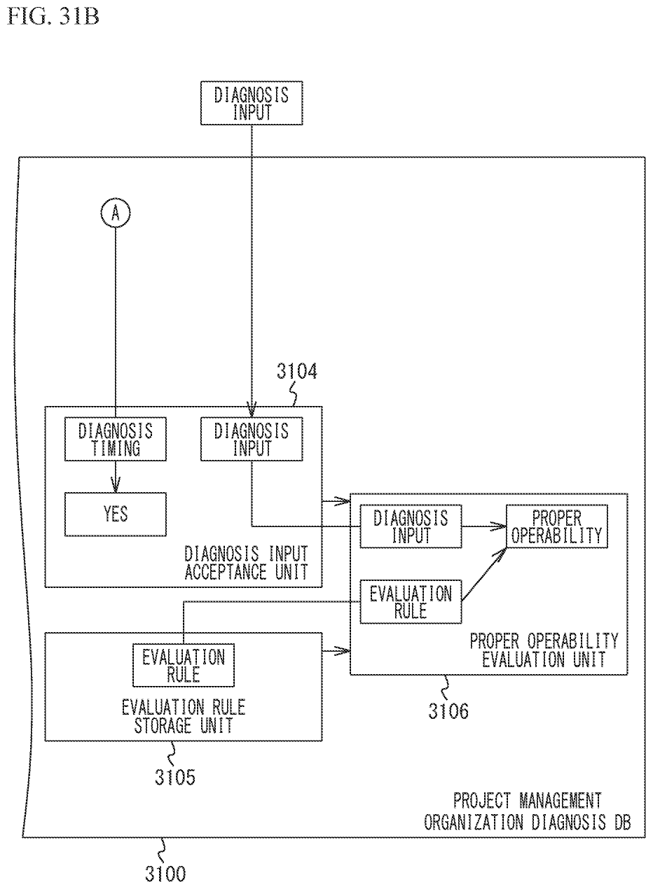

FIGS. 31A and 31B are diagrams illustrating the functional configuration according to the present embodiment. The project management organization diagnosis DB system (3100) of the present embodiment includes an organization diagnosis template storage unit (3101), an organization diagnosis template selection unit (3102), an organization diagnosis sheet registration unit (3103), an organization diagnosis input acceptance unit (3104), an evaluation rule storage unit (3105), and a proper operability evaluation unit (3106) as in the first embodiment, and further has an organization diagnosis template management unit (3107). The description will be made except for the functions already described.

The “organization diagnosis template management unit” has a function of managing the organization diagnosis template.

<Hardware Configuration>

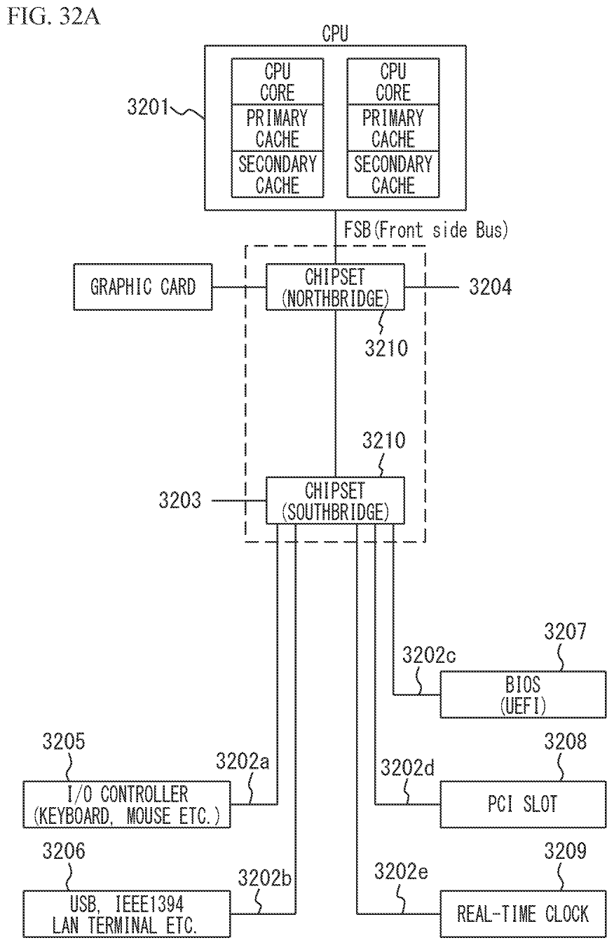

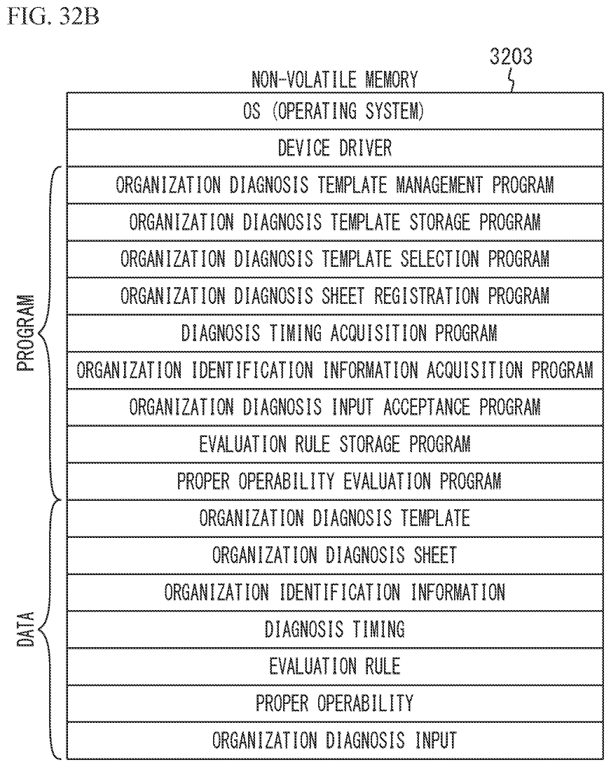

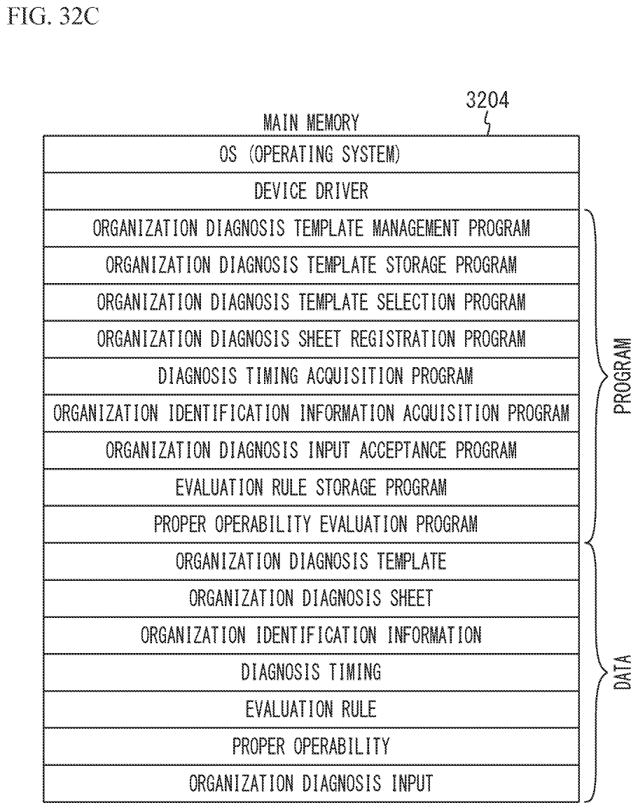

FIGS. 32A to 32C are diagrams illustrating a hardware configuration of the project management organization diagnosis DB system according to the present embodiment. As illustrated in FIGS. 32A to 32C, the computer includes a chip set (3210), a CPU (3201), a non-volatile memory (3203), a main memory (3204), various buses (3202a to 3202e), a BIOS (3207), various interfaces (3205, 3206, 3208), a real-time clock (3209), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 32A to 32C, the nonvolatile memory stores: an “organization diagnosis template storage program” for storing a plurality of organization diagnosis templates composed of diagnosis sentences in predetermined sentences for checking the proper operability of the a project management organization; an “organization diagnosis template selection program” for allowing the user to select an organization diagnosis template for checking the proper operability of the project management organization being operated; a “diagnosis timing acquisition program” for acquiring a diagnosis timing which is a timing for diagnosing a project management organization in order to associate it with the project diagnosis sheet to be described later; an “organization identification information acquisition program” for acquiring organization identification information, which is identification information of the organization to be diagnosed, in order to associate the organization identification information with the organization diagnosis sheet to be described later; an “organization diagnosis sheet registration program” for registering a selected diagnosis template as the project diagnosis sheet in association with information to be associated; an “organization diagnosis input acceptance program” for accepting an organization diagnosis input which is an input for judging whether the project management organization is properly operated for each diagnosis item of the organization diagnosis sheet; an “evaluation rule storing program” for storing evaluation rules to evaluate the accepted organization diagnosis input; and a “proper operability evaluation program” for evaluating the proper operability of the project management organization based on the stored evaluation rule and the inputted organization diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “organization diagnosis template management program” for managing the organization diagnosis template.

<Flow of Processing>

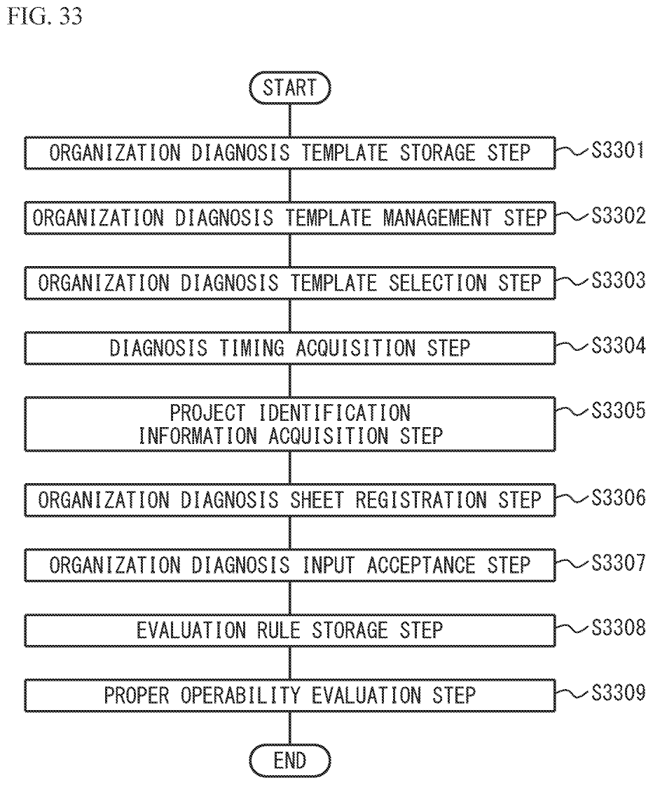

FIG. 33 is a diagram illustrating a flow of processing when the project management organization diagnosis DB system according to the present embodiment is used. The flow of processing of the present embodiment is an operation method of the project management organization diagnosis DB system which is a computer having an organization diagnosis template storage step (S3301), an organization diagnosis template management step (S3302), an organization diagnosis template selection step (S3303), a diagnosis timing acquisition step (S3304), an organization identification information acquisition step (S3305), an organization diagnosis sheet registration step (S3306), an organization diagnosis input acceptance step (S3307), an evaluation rule storage step (S3308), and a proper operability evaluation step (S3309). The steps other than the organization diagnosis template management step are the same as those in the first embodiment.

The “organization diagnosis template management step” is a step of managing the organization diagnosis template. This management allows the user to download, modify and upload data of the organization diagnosis template from the screen. The user can also remotely re-install the organization diagnosis template, or remotely install additional organization diagnosis template.

### Twelfth Embodiment

In addition to the above-described embodiments, the present embodiment provides a project management organization diagnosis DB system further including a functional unit for outputting an effective improvement measure for improving an evaluation value of the proper operability of the project management organization.

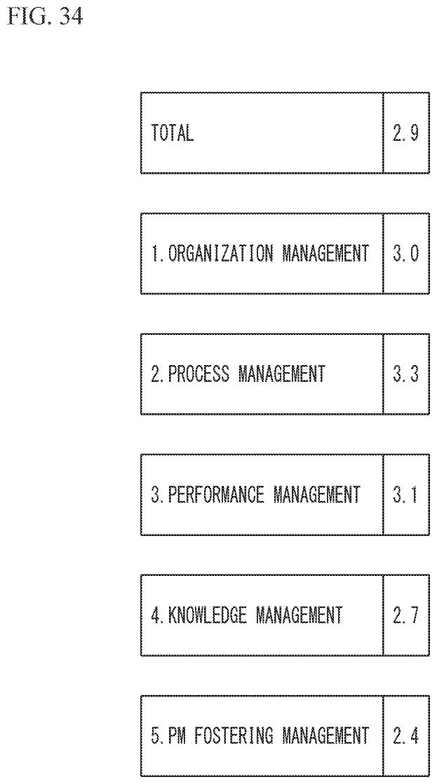

As illustrated in FIG. 34, each of a plurality of diagnosis items including diagnosis sentences belongs to any one of “organization management”, “process management”, “performance management”, “knowledge management”, and “PM (project manager) fostering management”.

### <Example of Organization Diagnosis Template>

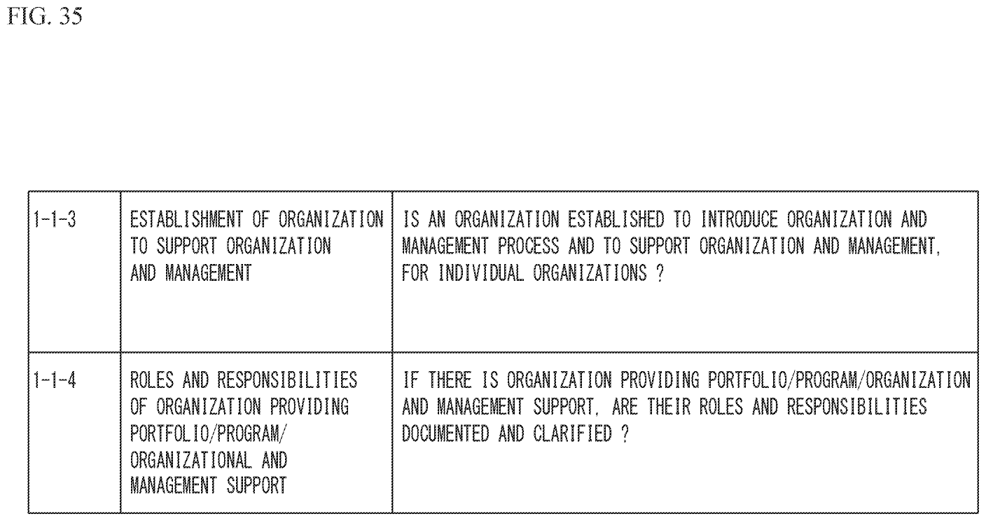

FIG. 35 illustrates a diagnosis sentence that prompts the user to answer whether a document exists that clarifies the roles and responsibilities of an organization supporting the project management. In FIG. 35, there is a diagnosis sentence stating “Is an organization established to introduce organization and management process and to support organization and management, for individual organizations?”.

Further, the organization diagnosis template may include a diagnosis sentence that prompts the user to answer whether information is shared with parties concerned, whether a consensus is formed with the parties concerned, or whether an intention is unified with the parties concerned. Specifically, it may be a diagnosis sentence stating “Are you explained the contents of the project plan to the main parties concerned in the project and obtained a consensus?”.

In addition, the organization diagnosis template may include a diagnosis sentence that prompts the user to answer whether a criterion for a problem to be immediately shared with a higher-level organization is clarified, whether quantitative management is performed, or whether a department and a plan corresponding to the problem are clarified. Specifically, it may be a diagnosis sentence stating “Is a criterion for sharing and communicating important problems to a higher-level layer, such as from a team to a project and from a project to a steering committee, clear?”.

What is claimed is:

1. A project management organization diagnosis DB system that diagnoses a proper operability which is information indicating whether a project management organization, which is an organization to manage a project, is properly installed and operated during the progress of the project, and provides a database storing a result of the diagnosis, comprising:
an organization diagnosis template storage configured to storage a plurality of organization diagnosis templates each provided with a plurality of diagnosis items composed of diagnosis sentences in predetermined sentences for checking the proper operability of a project management organization;
an organization diagnosis template selector configured to allow a user to select an organization diagnosis template for checking the proper operability of the project management organization being operated; and
an organization diagnosis sheet register configured to register the selected organization diagnosis template as an organization diagnosis sheet in association with information to be associated.

2. The project management organization diagnosis DB system according to claim 1, further comprising
an organization diagnosis sheet comparer configured to calculate an average value for each industry, each type of industry, or each type of project based on accumulated diagnosis result information of a plurality of organization diagnoses, and set target values classified into a high level target value, a standard target value, and a low level target value.

3. The project management organization diagnosis DB system according to claim 1, further comprising
a functional unit configured to output an effective improvement measure for improving an evaluation value of the proper operability of the project management organization.

4. The project management organization diagnosis DB system according to claim 1, wherein
each of the plurality of diagnosis items belongs to any one of organization management, process management, performance management, knowledge management, and project manager fostering management.

5. The project management organization diagnosis DB system according to claim 1, wherein
the organization diagnosis template includes at least a diagnosis sentence that prompts the user to answer whether a document exists that clarifies roles and responsibilities of an organization supporting a project management.

6. The project management organization diagnosis DB system according to claim 1, wherein
the organization diagnosis template includes at least a diagnosis sentence that prompts the user to answer whether information is shared with parties concerned, whether a consensus is formed with the parties concerned, or whether an intention is unified with the parties concerned.

7. The project management organization diagnosis DB system according to claim 1, wherein
the organization diagnosis template includes at least a diagnosis sentence that prompts the user to answer whether a criterion for a problem to be immediately shared with a higher-level organization is clarified, whether quantitative management is performed, or whether a department and a plan corresponding to the problem are clarified.
